(19) United States
(12) Patent Application Publication
(10) Pub. No.: US 2010/0053019 A1
(43) Pub. Date: Mar. 4, 2010

(54) Artificial medium, its manufacturing method, and antenna device

(75) Inventors: Kohji Ikawa, Tokyo (JP); Masahide Koga, Tokyo (JP); Ryuta Sonoda, Tokyo (JP); Fuminori Watanabe, Tokyo (JP); Kazuhiko Niwano, Tokyo (JP)

Correspondence Address: FOLEY AND LARDNER LLP;SUITE 500, 3000 K STREET NW, WASHINGTON, DC, 20007, US

(73) Assignee: Asahi Glass Company, Limited

(21) Appl. No.: 12/591,082

(22) Filed: Nov. 6, 2009

Related U.S. Application Data
(63) Continuation-in-part of application No. PCT/JP08/58565, filed on May 8, 2008.

(30) Foreign Application Priority Data
May 8, 2007 (JP) 2007-123638
Nov. 26, 2007 (JP) 2007-305098
Feb. 26, 2008 (JP) 2008-045071

(51) Int. Cl. H01Q 7/00; B32B 37/00; H04B 3/40

(52) U.S. Cl. 343/866; 156/60; 333/23

(57) ABSTRACT

An artificial medium on which two or more conductive surfaces are provided in a thickness direction, the conductive surface being provided with conductive elements in a two-dimensional periodic array, wherein when an electromagnetic wave propagated in parallel to the thickness direction is incident on the artificial medium, a current excited by the electromagnetic wave increases in an operation frequency, and a current loop is formed in a surface parallel to the thickness direction is provided.

### TECHNICAL FIELD

The present invention relates to an artificial medium, in particular, one which is also called meta-material. In addition, the invention relates to a method of manufacturing such an artificial medium and an antenna device using the artificial medium.

### BACKGROUND ART

A so-called artificial medium is a medium obtained by minutely and accurately arranging inclusion patterns such as metal so as to manifest material properties (effective relative permittivity and effective relative permeability) which cannot be obtained in nature. The artificial medium is expected to be used for application in various fields, such as high-frequency antennas, micromini resonators for communication, transmitters, and sub-wavelength focus lenses.

FIG. 1 shows an example a typical configuration of such an artificial medium. As shown in FIG. 1, the artificial medium 1 has a length W, width D, and thickness T. A medium 1 is configured such that plural dielectric layers 2 with a thickness t are substantially laminated in a longitudinal direction (X direction in the drawing) of the medium 1. In addition, the dielectric layer 2 includes an arrangement pattern of split rings 3 as inclusions on a conductive surface 4 (YZ plane in the drawing). Each of the split rings 3 has a separation portion 6 on the front side in the drawing (a negative side of the Y direction).

Next, characteristics of the medium configured as described above will be described with reference to FIGS. 2A and 2B. FIGS. 2A and 2B show a generating principle of increase in effective relative permeability in the artificial medium according to the related art.

When electromagnetic waves 5 propagated in the Z direction (an electric field direction E is the Y direction, and a magnetic field direction H is the X direction) are incident on the above-mentioned artificial medium 1, the currents flowing on an outer circumferential side and an inner circumferential side of the split ring 3 are reverse in direction to each other in a low frequency band. That is, on the outer circumferential side of the split ring 3, a current flow 8 in clockwise direction occurs, and on the inner circumferential side, a current flow 9 in counterclockwise direction occurs. Therefore, in this case, the magnetic fields generated by both the currents are canceled out by each other, and the effective relative permeability does not increase as a whole. However, when the frequency increases gradually, the current flowing in the split ring 3 jumps over the separation portion 6 at a frequency (resonant frequency), and a displacement current 7 occurs in the separation portion 6. In addition, by the displacement current, the current flows 8 and 9 in the same counterclockwise direction are generated on the outer peripheral side and the inner peripheral side of the split ring 3, so that the current flowing in the split ring 3 becomes a loop current. As a result of the generation of the loop current, a magnetic flux passing through the artificial medium becomes strong and the effective relative permeability of the artificial medium is remarkably improved.

The influence of this change of the effective relative permeability of the artificial medium with respect to the frequency is illustrated in the graph shown in the lower portion of FIGS. 2A and 2B. In the frequency region surrounded with a circle in the graph, the effective relative permeability increases remarkably due to the above-mentioned principle.

Regarding the artificial medium employing such a principle, a large number of proposals have been disclosed because various characteristics can be manifested by the shape and arrangement pattern of inclusions such as split rings or screw coils (for example, refer to JP-A-2006-245984, JP-T-2003-526423, and J. B. Pendry, “Magnetism from Conductors and Enhanced Nonlinear Phenomena”, IEEE Transaction on Microwave Theory and Technique, Vol. 47, No. 11 November 1999).

In the artificial medium according to the related art, in order to obtain the increase in the effect of the effective relative permeability as described above, there is a need to form the medium 1 such that the conductive surfaces 4 of the inclusions are arranged in parallel to each other with respect to the incident direction of the electromagnetic wave 5. This is because, in order to manifest the improvement in the effective relative permeability of the artificial medium using the frequency dependence in a current direction as described above, the conductive surfaces 4 of the inclusions must be arranged to traverse the magnetic field of the incident electromagnetic waves 5 in an amplitude direction H. Since such a relationship is necessary between the magnetic field direction H of the electromagnetic waves 5 and the conductive surfaces 4, when the artificial medium according to the related art is configured, the dielectric layers 2 are laminated along the longitudinal direction (X direction in FIG. 1) of the completed artificial medium. Therefore, in general, a receiving surface of the artificial medium (that is, a plane (XY plane) perpendicular to the incident direction of the electromagnetic wave) and the direction of the conductive surfaces 4 of the dielectric layers 2 are not matched with each other.

However, in this case, in order to obtain the artificial medium 1 with a length W by laminating the dielectric layers, a very large number of dielectric layers 2 must be laminated. For example, in a case of the dielectric layer with a thickness of about 1 mm, 100 dielectric layers must be laminated in order to obtain an artificial medium with a length W of 10 cm. Therefore, there is generated a problem in that the production cost of the artificial medium increases.

In addition, since there is a need to arrange at least one inclusion in each dielectric layer 2 constituting the artificial medium, the thickness T (the length in the Z direction in FIG. 1) of the artificial medium 1 cannot be formed less than the dimensions (about 5 to 20 mm in a normal microwave band) of the inclusion, which is quite natural. Therefore, in such a configuration according to the related art, there is a problem in that it is very difficult to downsize (particularly to thin) the artificial medium.

### DISCLOSURE OF THE INVENTION

### Problem that the Invention is to Solve

The invention has been made in the above circumstances, and an object is to provide an artificial medium which can be manufactured at a low cost and also be downsized, a method of manufacturing the artificial medium, and an antenna device using the artificial medium.

### Means for Solving the Problem

According to the invention, there is provided an artificial medium on which two or more conductive surfaces are provided in a thickness direction, the conductive surface being provided with conductive elements in a two-dimensional periodic array, wherein when an electromagnetic wave propagated in parallel to the thickness direction is incident on the artificial medium, a current excited by the electromagnetic wave increases in an operation frequency, and a current loop is formed in a surface parallel to the thickness direction.

Further, in the artificial medium of the invention, a dielectric layer may be interposed between the respective conductive surfaces, and the current loop may be formed in a region in which the respective conductive elements face each other in a thickness direction via each dielectric layer.

Further, in the artificial medium of the invention, the conductive surfaces each may have substantially the same arrangement pattern which is constituted by a plurality of conductive elements separated from each other, and the respective conductive elements may be uniformly positioned along the thickness direction. Specifically, the respective conductive elements may have substantially the same shape and dimension.

Further, in the artificial medium of the invention, inside the dielectric layer, a plurality of first linear conductor elements may be disposed in parallel to each other in the vicinity of a center portion in the thickness direction of the dielectric layer, the first linear conductor elements may extend substantially in a linear shape from one end of the dielectric layer to the other end thereof, and when seen from a direction perpendicular to the conductive surfaces, at least one of the first linear conductor elements may be disposed to be overlapped with at least any one of the conductive elements.

Further, in the artificial medium of the invention, the artificial medium may further includes a plurality of second linear conductor elements which are disposed in parallel to each other in the same depth position as that of the plurality of the first linear conductor elements, the plurality of the second linear conductor elements may extend substantially in a linear shape from one end of the dielectric layer to the other end thereof along a direction different from that of the first linear conductor elements, and when seen from a direction perpendicular to the conductive surfaces, at least a part of the plurality of second linear conductor elements may be disposed to be overlapped with at least any one of the conductive elements.

Here, when seen from a direction perpendicular to the conductive surfaces, the first and second linear conductor elements may be disposed such that intersections between the first linear conductor elements and the second linear conductor elements are included in a region of any conductive element.

Besides, aside from the above or further to the above, the conductive elements may be arranged at a constant pitch along rows and columns in the conductive surface, when seen from a direction perpendicular to the conductive surfaces, at least one of the first linear conductor elements may be disposed to be overlapped with the respective conductive elements constituting one column, and/or when seen from a direction perpendicular to the conductive surfaces, at least one of the second linear conductor elements may be disposed to be overlapped with the respective conductive elements constituting one row.

Further, in the artificial medium of the invention, the conductive elements may be arranged at a constant pitch along rows and columns in the conductive surface, the first linear conductor elements may be disposed at a pitch substantially equal to the pitch between the columns of the conductive elements, and/or the second linear conductor elements may be disposed at a pitch substantially equal to the pitch between the rows of the conductive elements.

Specifically, when seen from a direction perpendicular to the conductive surfaces, the conductive elements may be disposed on all of the intersections between the first and second linear conductor elements, and not be disposed on positions other than the intersections.

Besides, the conductive elements may be arranged at a constant pitch along rows and columns in the conductive surface, the first linear conductor elements may be disposed at a pitch substantially two times the pitch between the columns of the conductive elements, and/or the second linear conductor elements may be disposed at a pitch substantially two times the pitch between the rows of the conductive elements.

Further, in the above-mentioned artificial medium including a plurality of second linear conductor elements may be disposed in parallel to each other at a depth position substantially equal to the plurality of first linear conductor elements, the conductive elements may be arranged at a constant pitch along rows and columns in the conductive surface, the plurality of the first linear conductor elements and the second linear conductor elements may be disposed at the almost same space, the first linear conductor elements may be disposed to extend in a direction rotating by 45° in the clockwise direction with respect to a direction of the columns of the conductive elements, and the first linear conductor elements may be disposed to extend in a direction rotating by 45° in the counterclockwise direction with respect to a direction of the columns of the conductive elements.

Specifically, when seen from a direction perpendicular to the conductive surfaces, the conductive elements may be disposed on all of the intersections between the first and second linear conductor elements, and are not disposed on positions other than the intersections.

Besides, in the above artificial medium, the plurality of conductive elements may have substantially a square shape.

Further, a line width of the first linear conductor element and/or the second linear conductor element may be narrower or wider than a width of the conductive element in the same direction. Here, it should be noted that “width in the same direction of the conductive element” means the length of the conductive element when it is viewed in the same direction as the line width direction of the linear conductor element. For example, when the shape of the conductive element is a circle, the “width in the same direction of the conductive element” is a diameter thereof. In addition, when the shape of the conductive element is a rectangular shape and the longitudinal side thereof is arranged in parallel to the line width direction of the linear conductor element, the “width in the same direction of the conductive element” is a length of the longitudinal side. When the short side thereof is arranged in parallel to the line width direction of the linear conductor element, the “width in the same direction of the conductive element” is a length of the short side. When the diagonal line thereof is arranged in parallel to the line width direction of the linear conductor element, the “width in the same direction of the conductive element” is a length of the diagonal line.

Further, the dielectric layer may be configured of a fluororesin-based resin material.

Further, according to the invention, there is provides a method of manufacturing an artificial medium, comprising the steps of: preparing dielectric substrates each having a conductive surface on which conductive elements are disposed; and forming an artificial medium by laminating the dielectric substrates in a thickness direction, wherein the step of preparing the dielectric substrate may include a step of disposing the conductive elements in the respective dielectric substrates such that a current loop is formed in a plane parallel to the thickness direction, when an electromagnetic wave propagated in a direction parallel to the thickness direction is incident on the artificial medium.

Here, in the method, a current loop may be formed between the conductive elements facing to each other with one dielectric substrate interposed therebetween in the thickness direction.

Further, in the method, the step of forming the artificial medium by laminating the dielectric substrates in the thickness direction may include a step of interposing a second dielectric layer without the conductive elements between the dielectric substrates in which the conductive elements are disposed on the conductive surface.

Further, in the method, the step of preparing the dielectric substrate may further include the steps of: disposing linear conductor elements in the vicinity of the center portion in the thickness direction of the dielectric layer; and providing substantially the same pattern, which is constituted by a plurality of conductive elements, on a conductive surface of each dielectric substrate such that the conductive elements are uniformly positioned along the thickness direction, when the dielectric substrates are laminated, wherein the respective conductive elements may have substantially the same shape and dimension, the linear conductor elements may extend substantially in a linear shape from one end of the dielectric substrate to the other end thereof, and when seen from a direction perpendicular to the conductive surfaces, at least a part of the linear conductor elements may be disposed to be overlapped with at least any one of the conductive elements.

Further, according to the invention, there is provided an artificial medium including: a dielectric layer; and a single conductive element which is provided on each of front and rear surfaces of the dielectric layer, wherein the respective conductive elements have substantially the same shape and dimensions, and are uniformly positioned along a thickness direction of the dielectric layer, and when an electromagnetic wave propagated in a direction parallel to the thickness direction is incident, a current loop is formed on a region in which the conductive elements face each other with the dielectric layer interposed therebetween in the thickness direction.

Further, according to the invention, there is provided an antenna device in which an antenna element with a conductor is disposed on a first surface of a substrate which is constituted by an insulating body or a dielectric body, wherein an artificial medium is disposed on a second surface opposite to the first surface of the substrate, the artificial medium is constituted by the artificial medium according to claim 22, and when seen from a direction perpendicular to the first surface of the substrate, at least a part of the antenna element is overlapped with the artificial medium.

Here, the antenna device may further includes a metal plate on a side of the artificial medium opposite to the second surface of the substrate.

Further, in the antenna device, the antenna element has an RFID tag.

### ADVANTAGE OF THE INVENTION

The invention can provide an artificial medium which can be manufactured at a low cost and can be downsized, and a method of manufacturing the artificial medium. In addition, the invention can provide an antenna device using the artificial medium.

### BRIEF DESCRIPTION OF THE DRAWINGS

FIG. 1 is a perspective view schematically illustrating an example of a configuration of an artificial medium according to the related art.

FIGS. 2A and 2B are diagrams schematically illustrating a generating principle for increasing the effective relative permeability in the artificial medium according to the related art.

FIG. 3 is a perspective view illustrating an example of a configuration of an artificial medium according to a first embodiment of the invention.

FIG. 4 is an enlarged view schematically illustrating a part of a conductive surface of the artificial medium shown in FIG. 3.

FIG. 5 is an enlarged view taken along the line A-A of the artificial medium shown in FIG. 3, which illustrates a direction of current generated in a conductive element at low frequency band.

FIG. 6 is an enlarged view taken along the line A-A of the artificial medium shown in FIG. 3, which illustrates a direction of current generated in a conductive element at a high frequency band (resonant frequency).

FIGS. 7A to 7D are diagrams illustrating a relationship between a direction and a phase of current flowing in a conductive element.

FIG. 8 is a diagram illustrating a relationship between the frequency and effective relative permeability of an artificial medium shown in FIG. 3 in each electric field direction.

FIGS. 9A and 9B are diagrams illustrating a relationship between an electric field and a magnetic field in the vertical (Y) direction and horizontal (X) directions of a conductive element.

FIGS. 10A and 10B are diagrams schematically illustrating a configuration of an artificial medium according to a second embodiment of the invention.

FIGS. 11A and 11B are diagrams schematically illustrating a configuration of an artificial medium according to a first modified example of the second embodiment of the invention.

FIG. 12 is a diagram schematically illustrating a configuration of an artificial medium according to a second modified example of the second embodiment of the invention.

FIG. 13 is a diagram schematically illustrating a configuration of an artificial medium according to a third modified example of the second embodiment of the invention.

FIG. 14 is a diagram schematically illustrating a configuration of an artificial medium according to a fourth modified example of the second embodiment of the invention.

FIGS. 15A and 15B are diagrams schematically illustrating a configuration of an artificial medium according to a comparative example to the second embodiment of the invention.

FIG. 16 is a graph illustrating frequency dependence of the effective relative permittivity and effective relative permeability of the artificial medium shown in FIGS. 15A and 15B.

FIG. 17 is a graph illustrating frequency dependence of the effective relative permittivity and effective relative permeability of the artificial medium shown in FIGS. 11A and 11B.

FIGS. 18A and 18B are diagrams illustrating an upper surface and a sectional surface of an artificial medium according to a third embodiment of the invention.

FIG. 19 is an exploded perspective view schematically illustrating a first antenna device provided with the artificial medium shown in FIGS. 18A and 16B.

FIG. 20 is a cross-sectional view schematically illustrating the first antenna device.

FIG. 21 is a diagram illustrating a shape of a conductor of an antenna element in the first antenna device.

FIG. 22 is a top view illustrating a second antenna device provided with the artificial medium shown in FIGS. 18A and 18B.

FIG. 23 is a cross-sectional view taken along the line H-H of the second antenna device.

FIG. 24 is a top view illustrating a third antenna device provided with the artificial medium shown in FIGS. 18A and 18B.

FIG. 25 is a cross-sectional view taken along the line J-J of the third antenna device.

FIG. 26 is a diagram illustrating a part of a sectional surface of an artificial medium according to Example 1 of the invention.

FIG. 27 is a diagram schematically illustrating a measurement device of effective relative permittivity and effective relative permeability of the artificial medium according to Example 1.

FIG. 28 is a diagram illustrating a measurement result of S-parameter amplitude characteristics of the artificial medium according to Example 1.

FIG. 29 is a diagram illustrating a measurement result of S-parameter phase characteristics of the artificial medium according to Example 1.

FIGS. 30A and 30B are diagrams illustrating a calculation result of effective relative permittivity and effective relative permeability of the artificial medium according to Example 1.

FIGS. 31A and 31B are diagram illustrating a simulation result of effective relative permittivity and effective relative permeability of an artificial medium according to Example 2 of the invention.

FIGS. 32A and 32B are diagrams schematically illustrating a configuration of an artificial medium according to Example 3 of the invention.

FIG. 33 is a graph illustrating frequency dependence of the effective relative permittivity of the artificial medium according to Example 3.

FIG. 34 is a graph illustrating frequency dependence of the effective relative permeability of the artificial medium according to Example 3.

FIG. 35 is a graph illustrating frequency dependence of an effective refractive index of the artificial medium according to Example 3.

FIG. 36 is a graph illustrating frequency dependence of the normalized effective impedance of the artificial medium according to Example 3.

FIGS. 37A and 37B are diagrams schematically illustrating a configuration of an artificial medium according to Example 4 of the invention.

FIG. 38 is a graph illustrating frequency dependence of the effective relative permittivity of the artificial medium according to Example 4.

FIG. 39 is a graph illustrating frequency dependence of the effective relative permeability of the artificial medium according to Example 4.

FIG. 40 is a graph illustrating frequency dependence of the effective refractive index of the artificial medium according to Example 4.

FIG. 41 is a graph illustrating frequency dependence of the normalized effective impedance of the artificial medium according to Example 4.

FIGS. 42A and 42B are diagrams schematically illustrating a configuration of an artificial medium according to Example 5 of the invention.

FIG. 43 is a graph illustrating frequency dependence of the effective relative permittivity of the artificial medium according to Example 5.

FIG. 44 is a graph illustrating frequency dependence of the effective relative permeability of the artificial medium according to Example 5.

FIG. 45 is a graph illustrating frequency dependence of the effective refractive index of the artificial medium according to Example 5.

FIG. 46 is a graph illustrating frequency dependence of the normalized effective impedance of the artificial medium according to Example 5.

FIG. 47 is a graph illustrating frequency dependence of S11 characteristics of an antenna element.

FIG. 48 is a graph illustrating frequency dependence of S11 characteristics of an antenna device according to Example 6 of the invention.

FIG. 49 is a cross-sectional view schematically illustrating an antenna device according to Comparative Example 1.

FIG. 50 is a graph illustrating frequency dependence of S11 characteristics of the antenna device according to Comparative Example 1.

FIGS. 51A and 51B are diagrams schematically illustrating an antenna device according to Example 7 of the invention.

FIG. 52 is a graph illustrating characteristics of the antenna device according to Example 7.

FIG. 53 is a graph illustrating the influence of an arrangement direction of RFID tags on a real part of input impedance in the antenna device according to Example 7.

FIG. 54 is a graph illustrating the influence of an arrangement direction of RFID tags on an imaginary part of input impedance in the antenna device according to Example 7.

FIGS. 55A and 55B are a top view and a cross-sectional view of a single antenna element.

FIG. 56 is a graph illustrating S11 characteristics of the single antenna element shown in FIGS. 55A and 55B.

FIG. 57 is a graph illustrating S11 characteristics of an antenna device according to an eighth embodiment of the invention.

FIG. 58 is a graph illustrating characteristics of the antenna device according to the eighth embodiment when no artificial medium is provided.

FIG. 59 is a top view illustrating an antenna device according to a ninth embodiment of the invention.

FIG. 60 is a graph illustrating characteristics of the antenna device according to the ninth embodiment.

FIG. 61 is a graph illustrating characteristics of the antenna device according to the ninth embodiment when no artificial medium is provided.

FIG. 62 is a graph illustrating characteristics of an antenna device according to Example 10 of the invention.

FIG. 63 is a graph illustrating characteristics of the antenna device according to Example 10 when no artificial medium is provided.

FIG. 64 is a top view schematically illustrating an antenna device according to Example 11 of the invention.

FIG. 65 is a graph schematically illustrating an antenna device according to Example 11.

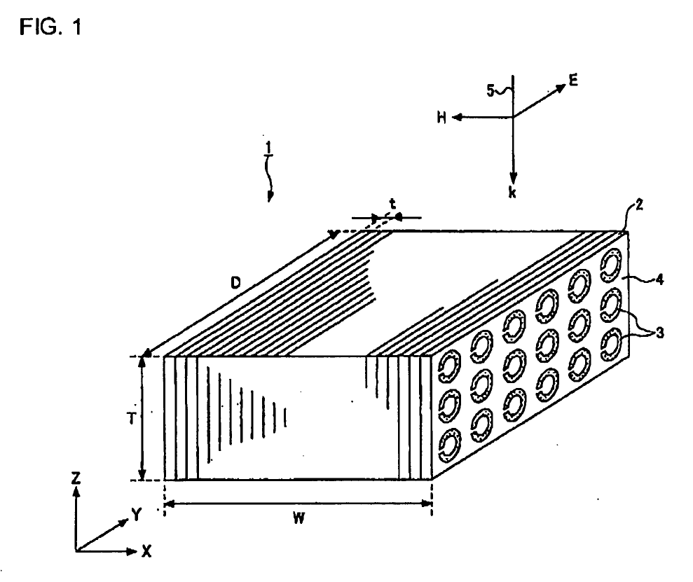

### BEST MODE FOR IMPLEMENTING THE INVENTION

Hereinafter, embodiments of the invention will be described with reference to the accompanying drawings.

### First Embodiment

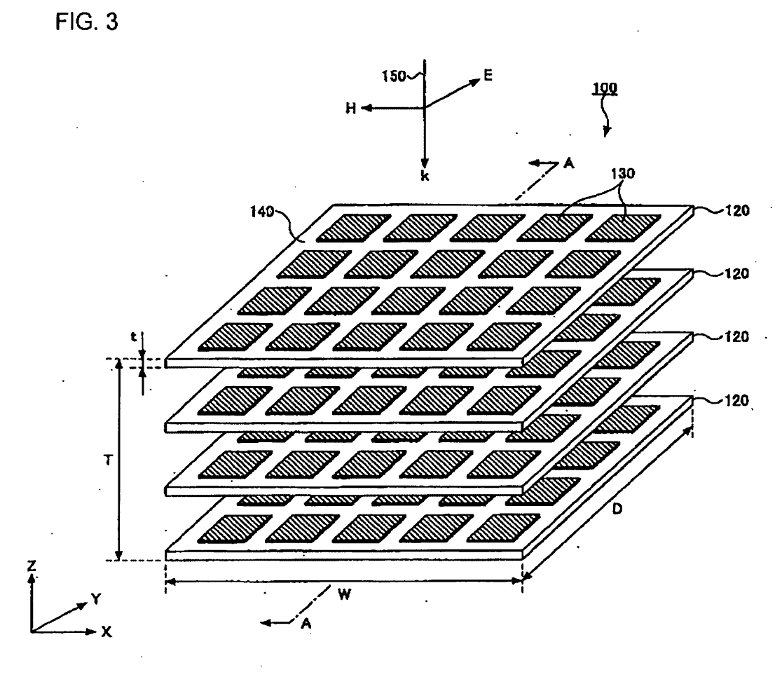

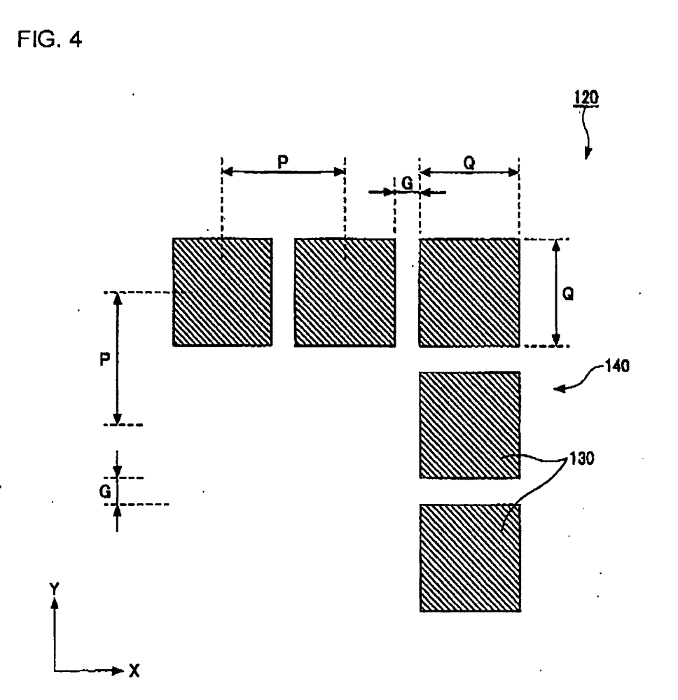

FIG. 3 shows a perspective view illustrating an example of a configuration of the artificial medium according to the invention. In addition, FIG. 4 shows an enlarged view illustrating the conductive elements which are disposed on the conductive surface of the dielectric layer constituting the artificial medium according to the invention.

As shown in FIG. 3, the artificial medium 100 according to the invention is substantially configured such that plural dielectric layers 120 with a length W (the length in the X direction shown in FIG. 3), a width D (the length in the Y direction shown in FIG. 3), and a thickness t (the length in the Z direction shown in FIG. 3) are laminated along the thickness direction. Here, in FIG. 3, in order to clarify the description, the artificial medium is illustrated as an exploded view in which the respective dielectric layers 120 are separated. However, in a real medium according to the invention, it should be noted that the respective dielectric layers are laminated in a state not coming into contact with each other. The artificial medium 100 has the length W, the width D, and the thickness T, and the thickness T of the artificial medium 100 is substantially determined by the thickness t of the dielectric layer 120×the number of the laminated layers. Further, in the embodiment shown in FIG. 3, the number of the laminated layers of the dielectric layers 120 is 4, but this is merely an example. The number of the laminated layers of the dielectric layers 120 when the artificial medium 100 is configured is not particularly limited. The dimensions of the dielectric layer 120 are, for example, W=10 cm, D=10 cm, and t=0.2 mm.

In FIG. 3, the dielectric layer 120 has a conductive surface 140 which is extended on the XY plane. On the conductive surface 140, plural conductive elements 130 are arranged. For example, in the embodiment shown in FIG. 3, five conductive elements 130 are arranged along the length direction (the X direction) of the dielectric layer 120, and four conductive elements are arranged along the width direction (the Y direction) of the dielectric layer 120, and thus in one conductive surface 140, twenty conductive elements 130 are arranged. Further, in the embodiment shown in FIG. 3, the conductive element 130 is in a square shape, but the conductive element 130 may be in another shape, for example, a rectangular shape, a triangular shape, a polygonal shape, a circular shape, an ellipsoid shape, or the like.

As shown in FIG. 4, the length of one side of the square conductive element 130 formed on the conductive surface 140 of the dielectric layer 120 is Q. The arrangement pitch of the conductive elements 130 (the distance between the center of one square conductive element 130 and the center of the adjacent square conductive element 130) is P in both the X and Y directions. The gap between the conductive elements 130 is G in both the X and Y directions. In this case, these dimensions are merely an example, and the arrangement pitch and the gap may be different in the X direction and the Y direction. In addition, the thickness of the conductive element 130 is not particularly limited, which is 18 to 20 μm in the embodiment shown in FIG. 3. In addition, the material of the conductive element 130 is not particularly limited as long as the conductive element has electrical conductivity. For example, the conductive element is composed of metal such as copper. In addition, the arrangement pattern of such conductive elements 130 can be easily formed by using an existing etching technique or the like.

Here, when the artificial medium is being manufactured, for example, after plural dielectric layers 120 are laminated, a uniform load is applied on the artificial medium along the laminating direction (the Z direction). In addition, in this state, a thermal treatment is carried out, so that the respective dielectric layers 120 are bonded to each other in the laminating direction. At this time, the conductive elements 130 provided on the conductive surface 140 of each dielectric layer are buried in the rear surface (the surface opposite to the conductive surface 140) of the adjacent dielectric layer 120. Therefore, in practice, in the interface between one dielectric layer 120 and the adjacent dielectric layer thereto, there is a need to note that there is no unevenness due to the conductive elements.

Next, characteristics of the artificial medium according to the invention, which is configured as described above, will be described.

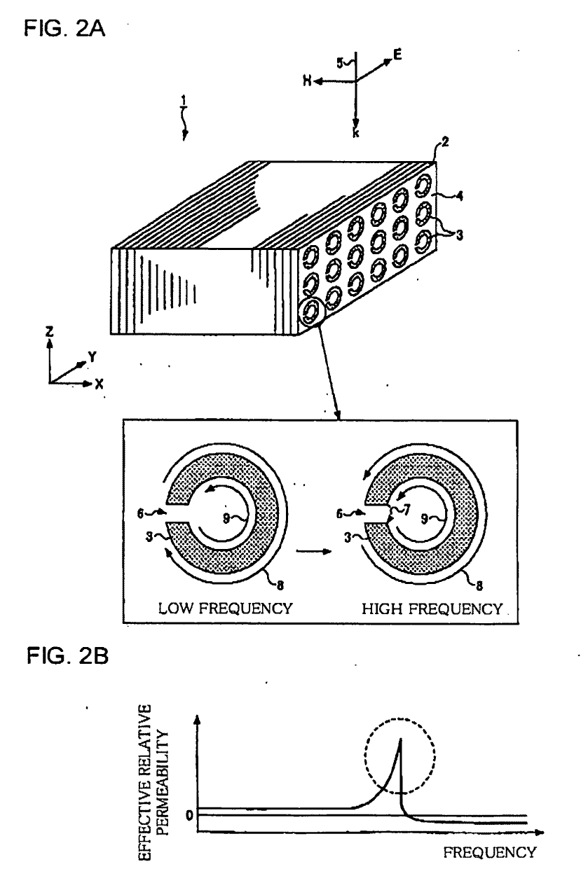

In the beginning, as shown in FIGS. 2A and 2B, in the artificial medium according to the related art, the medium 1 is disposed such that the conductive surfaces 4 of the respective dielectric layers 2 are arranged in parallel to a propagation direction k of an electromagnetic wave. The reason for the above-mentioned arrangement is because a current loop is not formed in the artificial medium in the resonance frequency band. Therefore, in a general case, the conductive surface is not matched with the surface (hereinafter, referred to as “receiving surface”) of the artificial medium perpendicular to the propagation direction of the electromagnetic wave.

In the invention, the artificial medium 100 is configured such that the conductive surfaces 140 of the respective dielectric layers 120 are disposed so as to be perpendicular to the propagation direction k of the incident electromagnetic wave 150 (see FIG. 3). Therefore, the receiving surface of the artificial medium receiving the electromagnetic wave 150 is matched with the conductive surface 140.

In such a case of disposition, since the conductive surfaces 140 of the dielectric layers 120 constituting the artificial medium 100 can serve as the receiving surfaces, the number of the laminated layers of the dielectric layers 120 can be remarkably reduced compared with the artificial medium 1 according to the related art as described above. For example, when the artificial medium with a length W of 10 cm (the thickness T=5 mm) is configured, there is a need to laminate 500 (which is calculated simply) dielectric layers on the dielectric layer 2 with the thickness t of 0.2 mm according to the related art. However, in the case of the configuration according to the invention, the lamination can be completed with only 25 layers on the dielectric layer 120 with the same thickness t. Therefore, it is possible to significantly suppress the manufacturing cost of the medium. In addition, in the artificial medium 1 according to the related art, the current loop is determined by the inclusion, but since it is difficult to thicken the inclusion while processing and the characteristics are degraded, the medium cannot be made thin. On the other hand, the invention is suitable for making the current loop thin and for dense packing, and the characteristics are not degraded, and thus the small thickness can be achieved at a low cost. Furthermore, in the medium according to the invention, the conductive elements may be disposed in a simple shape (for example, a rectangular shape, a circular shape, etc.), so that there is no need to form the inclusion on the conductive surface so as to be in a complicated shape such as a split ring or a screw coil according to the related art. In addition, such a conductive element can be easily formed by an etching technique or a printing technique according to the related art. Therefore, in the invention, there can be obtained the effect that the configuration of the conductive surface of the artificial medium is simplified and the manufacturing is carried out easily.

Next, in the artificial medium 100 according to the invention, the reason that the receiving surface of the artificial medium receiving the electromagnetic wave 150 is matched with the conductive surface 140 will be described.

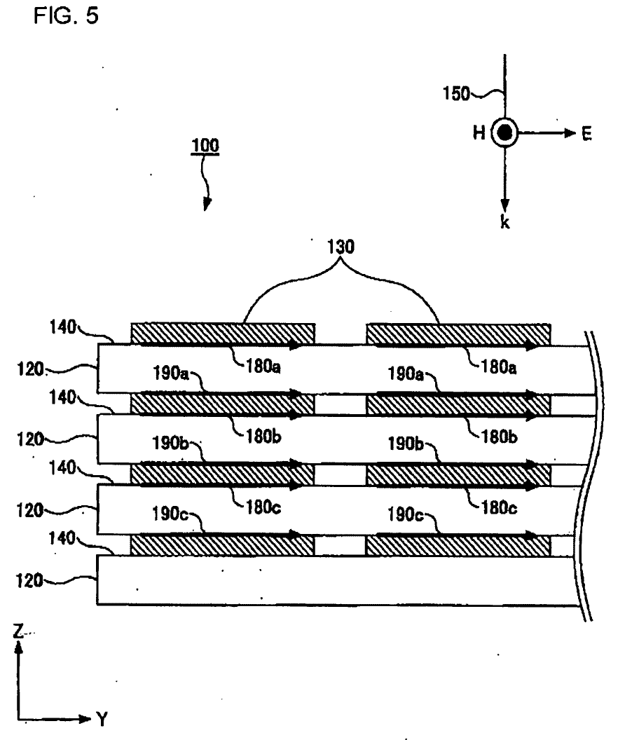

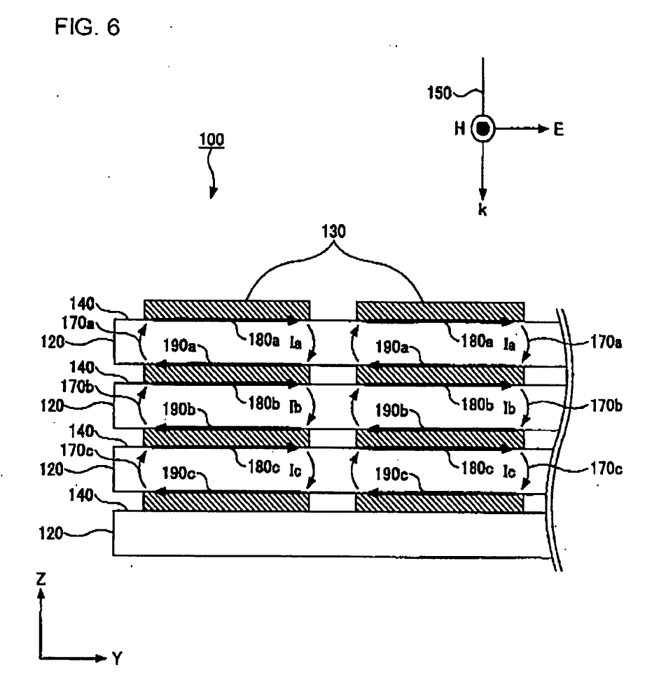

FIGS. 5 and 6 show enlarged cross-sectional views taken along the line A-A of the artificial medium 100 shown in FIG. 3 according to the invention. In these drawings, the direction of the current generated on the up and down sides of the surfaces of the conductive element 130 is also illustrated. In particular, FIG. 5 shows a current direction which is generated in the conductive element of the artificial medium at a low frequency band. In addition, the current direction shown in FIG. 6 illustrates a current direction generated on the conductive element of the artificial medium in a high frequency band. Further, in both the drawings, it should be noted that the direction of the arrow indicating the current is important and the magnitude of the arrow has no particular meaning. That is, the length of the arrow is arbitrarily set, and the magnitude of each real current may be equal to or different from that shown in the drawing. In addition, in the embodiment shown in these drawings, the artificial medium 100 according to the invention is configured such that four dielectric layers 120 are laminated in the Z direction.

When the electromagnetic wave 150 propagated from top to bottom (the negative direction of the Z direction) is incident on the artificial medium 100 according to the invention, the current shown in FIG. 5 flows in the conductive element 130 at a low frequency band. That is, as viewed on each conductive element, directions 190a, 190b, and 190c of the currents on the upper surface side of each conductive element 130 are equal to directions 180a, 180b, and 180c of the currents on the lower surface side. Therefore, in this case, the current loop is not formed, and the increase in the effective relative permeability does not occur. On contrary, displacement currents 170 are generated at a high frequency band, so that the currents flow in directions on both the surfaces of the conductive element 130 as shown in FIG. 6, as viewed on one conductive element. The directions of the currents 190a, 190b, and 190c on the upper surface side of the conductive element 130 are exactly opposite to the directions of the currents 180a, 180b, and 180c on the lower surface side. As can be seen in one dielectric layer 120, by the flow of the currents 180a, 180b, and 180c upside the conductive element 130 (that is, which is arranged on the conductive surface 140 of the dielectric layer), the flow of the currents 190a, 190b, and 190c downside the conductive element 130 (that is, which is arranged on the conductive surface 140 adjacent to the lower dielectric layer), and the flow of the displacement currents 170a, 170b, and 170c which transversely flow into the dielectric layer, the loop currents Ia, Ib, and Ic are generated in the plane (the YZ plane) parallel to the electromagnetic wave 150 of the artificial medium 100. As a result of the generation of the loop currents Ia, Ib, and Ic in the laminating direction of the dielectric layer 120 as described above, the magnetic flux increases, and the effective relative permeability of the artificial medium increases remarkably.

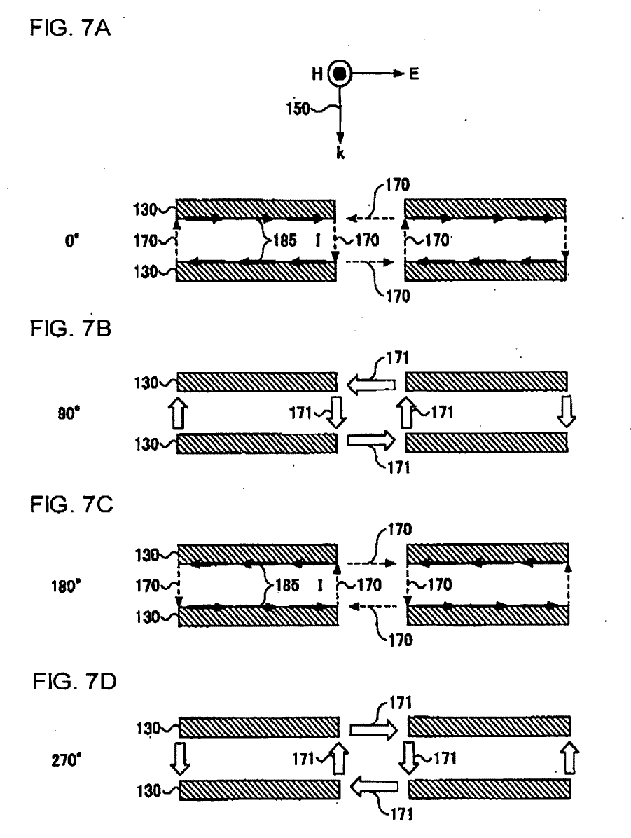

In FIGS. 7A to 7D, the relationship between the flow and the phase of the currents generated in the conductive element 130 and the dielectric layer 120 will be described in detail. When the electromagnetic wave 150 is incident from a direction perpendicular to the conductive surface 140 of the dielectric layer 120, the currents 185 excited by an external electric field are generated, in the opposite direction to each other, on one set of the conductive elements 130 facing to each other via the thickness portion of the dielectric layer 120. In addition, at this time, on the end portions of the respective conductive elements 130, the displacement currents 170 in an opposite direction are generated in a direction parallel to the laminating direction of the dielectric layer. With the currents 185 and the displacement currents 170, the current loop I is formed. This state is referred to as a phase 0°. Next, in a phase 90°, between one set of the conductive elements 130, an electric field 171 in the same direction as that of the displacement current 170 is generated on a position of the above-mentioned displacement current 170. Furthermore, in a phase 180°, the currents 185 are generated in an opposite direction to that in the phase 0°. In addition, in a phase 270°, the electric field 171 is generated in an opposite direction to that in the phase 90°.

Here, it is important that the magnetic field generated by the current loop I is in the same direction as the direction H of the magnetic field of the incident electromagnetic wave 150, so that it is possible to make the magnetic field strong by forming the current loop I.

Here, the relationship between the number of the laminated layers of the dielectric layers and the characteristics will be described. The dielectric layers are laminated with three layers or more, so that the frequency characteristics of the effective relative permeability can be controlled. Basically, by whether or not the current loop is formed by the conductive elements facing to each other, the frequency by which the effective relative permeability increases is determined. For example, when the number of the laminated layers is 4, the current loop is formed as a basic mode by the conductive elements in the outermost layers, and the current loop is formed by the conductive elements on two layers in the center at a frequency higher than the determined frequency. Therefore, plural peaks of the effective relative permeability can be formed, and thus multi-banding can be obtained. Furthermore, the thickness between the respective layers and the size of the conductive element is adjusted for each layer, so that it is possible to achieve a widened band.

In the invention as described above, the loop current can be generated in the plane parallel to the laminated direction of the dielectric layers constituting the artificial medium. This means that the receiving surface of the artificial medium can be vertically disposed with respect to the incident direction of the electromagnetic wave. In this case, the receiving surface of the artificial medium can be matched with the conductive surface of the dielectric layer. Therefore, similar to the artificial medium according to the related art, there is no need to configure the receiving surface by laminating a large number of the dielectric layers in the thickness direction of the dielectric layer. In addition, the number of the laminated layers of the dielectric layers can be reduced remarkably.

In addition, in the artificial medium 100 shown in FIG. 3, since the aspect ratio of the longitudinal and lateral sides of each conductive element 130 is small (that is, the widths of the longitudinal and lateral sides are substantially equal to each other), it is characterized in that the value of the effective relative permeability is hardly affected by a polarized wave (the direction of the electric field E) of the incident electromagnetic wave 150.

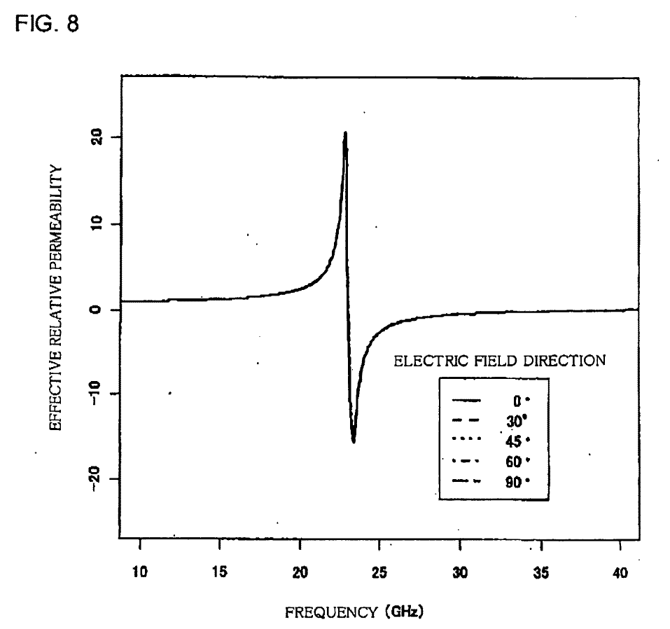

FIG. 8 shows the relationship between the frequency and the effective relative permeability in the artificial medium 100 (the number of the laminated layers of the dielectric layers 120: 3), which is obtained when the direction of the electric field of the incident electromagnetic wave propagated in a direction parallel to the thickness direction is changed. Further, the electric field direction 0° corresponds to a direction (that is, the Y direction) of the electric field E of the electromagnetic wave 150 in FIG. 3, and the electric field direction 900 means the X direction in FIG. 3. In FIG. 8, it can be seen that, even though a direction of the electric field of the incident electromagnetic wave is changed in a range from 0° to 90°, the relationship between the frequency and the effective relative permeability is hardly changed. As a result, the influence that the direction of the electric field of the incident electromagnetic wave has on the effective relative permeability is significantly reduced, and thus the polarization dependency of the effective relative permeability can be regarded as small in the artificial medium 100.

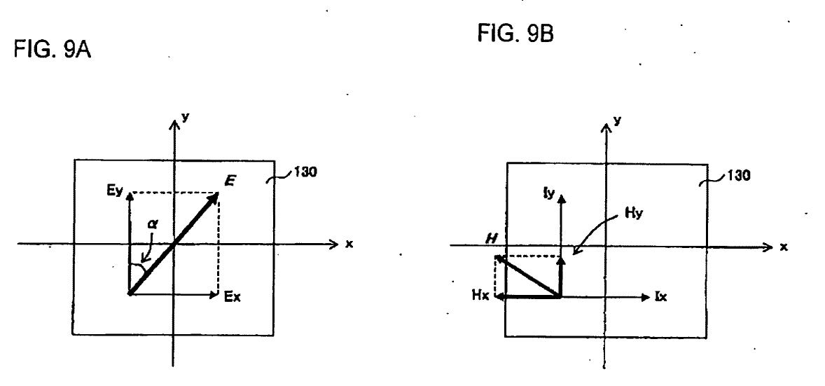

Further, the reason that the effect as described above is obtained can be considered as the following. As shown in FIGS. 9A and 9B, an angle which is formed between a y axis and the electric field E of the incident electromagnetic wave is set to α, and the electric field E is decomposed into an x component (Ex) and a y component (Ey), and the phenomenon that each component acts on the conductive element is vector-synthesized. The x component Ex of the electric field E is proportional to an x component Ix of the current I, and Ix is proportional to the y component Hy of the magnetic field H. This is also the same in the y components of the electric field and the current Ey and Iy, and the x component Hx of the magnetic field. The relationship is valid for any α. On the other hand, since the length in the X direction and the length in the Y direction of the conductive element are equal to each other, magnetic resonance frequencies are also equal, and phases of the x and y components Hx and Hy of the magnetic field are also equal. Therefore, at any angle α, the magnitude of the synthesized magnetic field H is not changed, and the direction thereof is perpendicular to the electric field E. As a result, the influence that the direction of the electric field of the incident electromagnetic wave has on the effective relative permeability is significantly reduced.

In addition, in the artificial medium 100 as described above, the width of the longitudinal and lateral sides and the arrangement pitches in the X and Y directions of the conductive elements 130, and the gap between the conductive elements 130 can be composed separately and freely, so that it is possible to easily manifest various functions.

### Second Embodiment

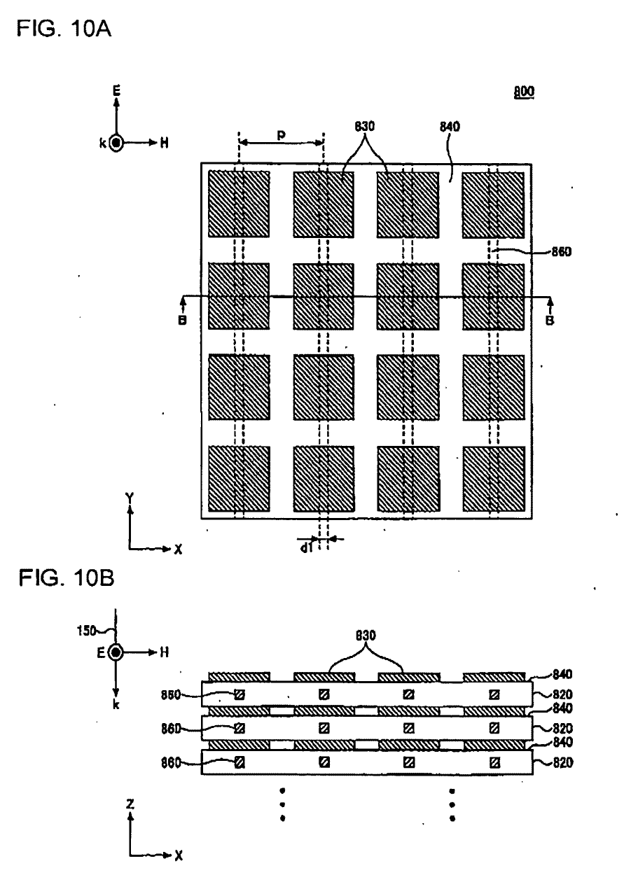

Next, an example of a configuration of the artificial medium according to the second embodiment of the invention will be described with reference to FIGS. 10A and 10B. FIG. 10A is a top view of the artificial medium 800, and FIG. 10 is a cross-sectional view taken along the line B-B.

Similar to the above-mentioned artificial medium 100, the artificial medium 800 is configured such that plural dielectric layers 820 each having the conductive surface 840 are laminated. In addition, on the conductive surface 840, plural conductive elements 830 are disposed as described above. In this case, the artificial medium 800 is different from the above-mentioned artificial medium 100 in that plural linear conductor elements 860 are provided in each dielectric layer 820. Further, the linear conductor element 860 may be made of the same material as that of the conductive element 830.

The respective linear conductor elements 860 have substantially the same line width d1 (length in the X direction) and are straightly extended in parallel to each other from one end of the dielectric layer 840 to the other end thereof (along the Y direction in FIGS. 10A and 10B). As shown in FIG. 10B, the respective linear conductor elements 860 are substantially provided in the center portion of the thickness of each dielectric layer 820, and the position in the X direction is disposed so as to be substantially overlapped with the region of the conductive elements 830 (in particular, in the embodiment shown in FIGS. 10A and 10B, the respective linear conductor elements 860 are disposed so as to be overlapped with the vicinity of the center portion of the conductive elements 830). In addition, the line width d1 of each linear conductor element 860 is smaller than the width (the width in the X direction) of the conductive element 830. Here, in the embodiment shown in FIGS. 10A and 10B, the respective linear conductor elements 860 are disposed at a constant interval (pitch), and the pitch is substantially matched with the arrangement pitch P in the X direction of the conductive elements 830. In this case, the invention is not limited to such a configuration. For example, the respective linear conductor elements 860 may be disposed at a random interval. Alternatively, the pitch between the respective linear conductor elements 860 may be different from the arrangement pitch P in the same direction of the conductive elements 830.

Even in the artificial medium 800 as described above, the receiving surface receiving the incident electromagnetic wave 150 is matched with the conductive surface 840, and the above-mentioned effect can be obtained. (In this case, in order to obtain good characteristics, it should be noted that there is a need to dispose the linear conductor elements 860 such that the extending direction (the Y direction) of the linear conductor element 860 is parallel to the direction of the electric field E of the incident electromagnetic wave.) In addition, in the artificial medium 800 as described above, the shapes and the arrangement of the conductive elements 830 and the linear conductor elements 860 can be composed separately and freely, so that it is possible to manifest various functions. For example, as described later, the artificial medium 800 can be used as a left handed metamaterial having a frequency region in which both the permittivity and the permeability are negative at the same time.

Further, in the embodiment shown in FIGS. 10A and 10B, the linear conductor elements 860 are disposed so as to be extended along the Y direction, but the invention is not limited to such a configuration. That is, the linear conductor elements 860 may be extended in any direction as long as at least a part thereof is overlapped with the conductive element as viewed in a direction perpendicular to the conductive surface.

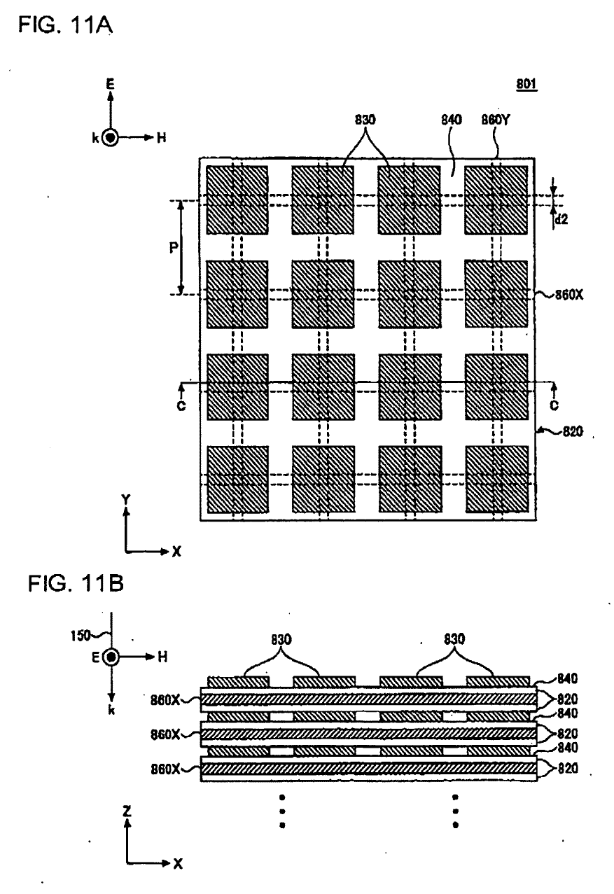

FIGS. 11A to 14 show modified examples of the artificial medium which has the linear conductor elements.

The artificial medium 801 (a first modified example) shown in FIG. 11A and FIG. 11B which is the cross-sectional view taken along the line C-C in FIG. 11A is configured significantly similar to the artificial medium 800 shown in FIGS. 10A and 10B. However, in this case, the artificial medium 801 is different from the artificial medium 800 in that, in each dielectric layer 820, plural linear conductor elements 860Y (which correspond to the linear conductor elements 860 shown in FIGS. 10A and 10B) which are extended from one end of the dielectric layer 820 to the other end thereof along the Y direction, and furthermore plural linear conductor elements 860X which are extended from one end of the dielectric layer 820 to the other end thereof along the X direction are formed. Further, the linear conductor element 860X may be made of the same material as that of the linear conductor element 830. The respective linear conductor elements 860X have substantially the same width d2 (the length in the Y direction), and are straightly extended in parallel to each other. In addition, the respective linear conductor elements 860X are substantially provided in the center portion of the thickness of each dielectric layer 820, and the position in the Y direction is disposed so as to be substantially overlapped with the region of the conductive elements 830 (in the embodiment shown in FIGS. 11A and 11B, the respective linear conductor elements 860X are disposed so as to be overlapped with the vicinity of the center portion of the conductive elements 830). Further, in the embodiment shown in FIGS. 11A and 11B, a pitch in the Y direction of the linear conductor elements 860X is constant, and the pitch is substantially matched with the arrangement pitch P in the same direction of the conductive elements 830. In this case, the respective linear conductor elements 860X may be disposed at a random interval. Alternatively, the pitch between the respective linear conductor elements 860X may be different from the arrangement pitch P in the same direction of the conductive elements 830.

In the artificial medium 801 configured as described above, the magnetic field direction of the incident electromagnetic wave may be parallel to the extending direction of the linear conductor elements 860X, or parallel to the extending direction of the linear conductor elements 860Y. Therefore, compared with the above-mentioned artificial medium 800, the arrangement dependency on the direction of the electric field and magnetic field of the electromagnetic wave 150 is reduced, and the flexibility regarding application is further increased.

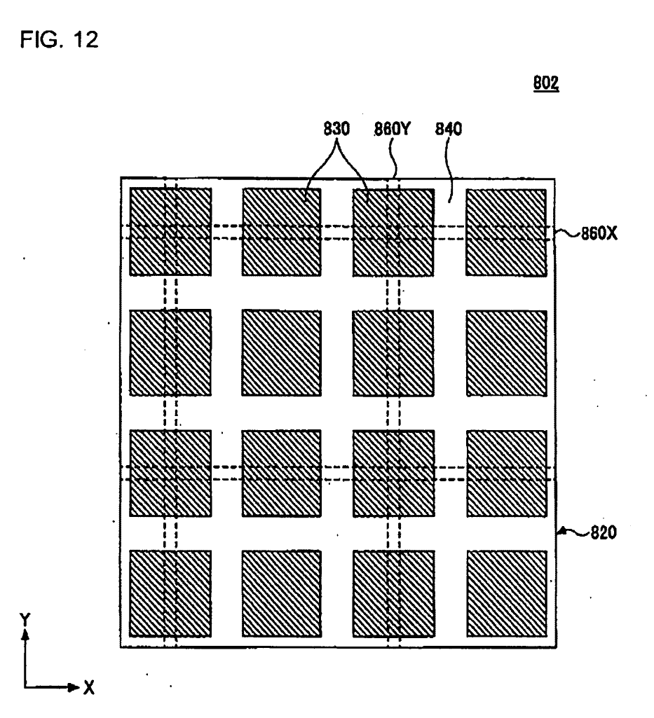

The artificial medium 802 (the second modified example) shown in FIG. 12 is configured substantially similar to the artificial medium 801 shown in FIGS. 11A and 11B. The pitches of the linear conductor elements 860X and 860Y increase to two times the arrangement pitches of the Y and X directions of the artificial medium 801, respectively.

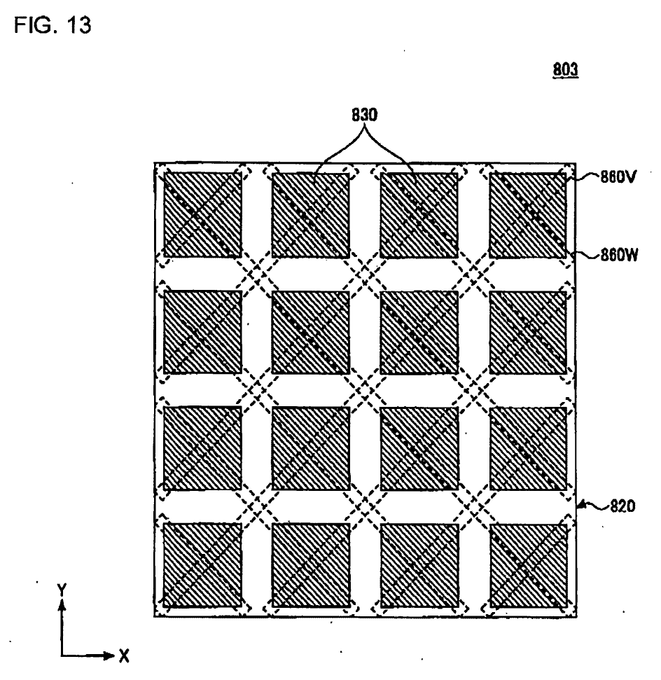

In addition, the artificial medium 803 (the third modified example) shown in FIG. 13 is configured substantially similar to the artificial medium 801 as shown in FIGS. 11A and 11B. However, in this case, two kinds of the linear conductor elements (the linear conductor elements 860V and 860W) are extended in a direction rotated by 45° from the X and Y directions, respectively.

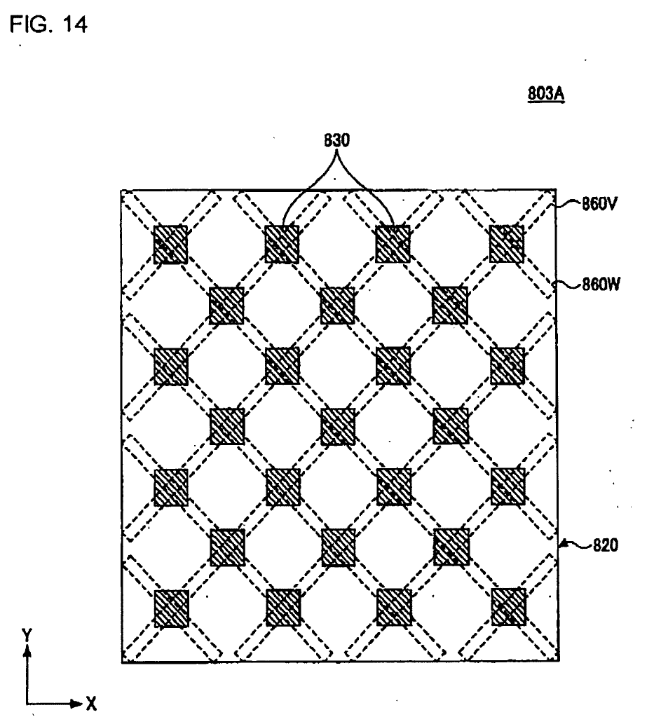

In addition, the artificial medium 803A (the fourth modified example) shown in FIG. 14 is configured substantially similar to the artificial medium 803 shown in FIG. 13. However, in this case, the conductive elements 830 are disposed on all the intersections between the linear conductor elements 860V and 860W as viewed from the thickness direction of the artificial medium.

Furthermore, besides the above-mentioned arrangement, the conductive element and the linear conductor element may be made in various arrangements (not shown in the drawings), which will be apparent to those skilled in the art.

In the artificial medium having the linear conductor elements 860X (hereinafter, referred to as “the first linear conductor element”) and 860Y (hereinafter, referred to as “the second linear conductor element”) which are extended in two directions as described above, it is preferable that the conductive elements 830 be disposed on the intersections between the linear conductor elements 860X and the linear conductor elements 860Y (that is, the configuration of the artificial medium 801 shown in FIGS. 11A and 11B) as viewed from a direction parallel to the thickness direction of the artificial medium. Hereinafter, the reason will be described.

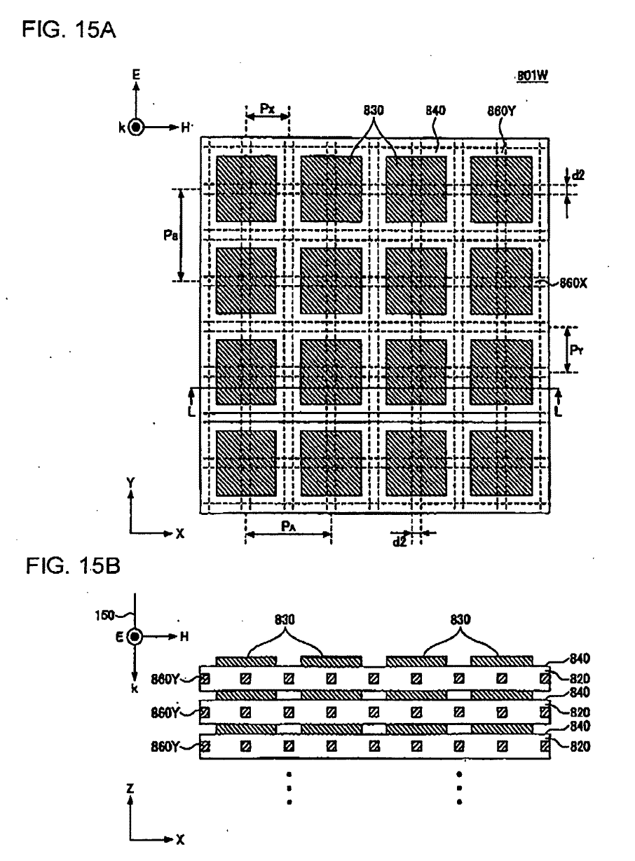

For example, as schematically shown in FIGS. 15A and 15B, when the pitch between the first linear conductor elements 860X is set to P_{Y} and the pitch between the second linear conductor elements 860Y is set to P_{X}, it can be assumed that the arrangement pitch P_{A} in the X direction of the conductive elements 830 and the arrangement pitch P_{B} in the Y direction come to be P_{A}=2P_{X} and P_{B}=2P_{Y}. Here, the respective conductive elements 830 are disposed on the intersections between the first linear conductor elements 860X and the second linear conductor elements 860Y as viewed from a direction parallel to the thickness direction of the artificial medium. In this case, in the artificial medium 801W (Comparative Example), there are intersections (8 places) between the linear conductor elements on which the conductive elements are not disposed in the vicinity of each conductive element 830 as viewed in the thickness direction of the artificial medium. That is, in the artificial medium 801W, the vicinity of each conductive element 830 is completely surrounded by the first and second linear conductor elements as viewed from a direction parallel to the thickness of the artificial medium. In addition, it can be also regarded as that the conductive surface 840 is disposed as “the conductive element surrounded by a frame” so to speak. Further, the configuration of the artificial medium 801W is similar to that of the above-mentioned artificial medium 801.

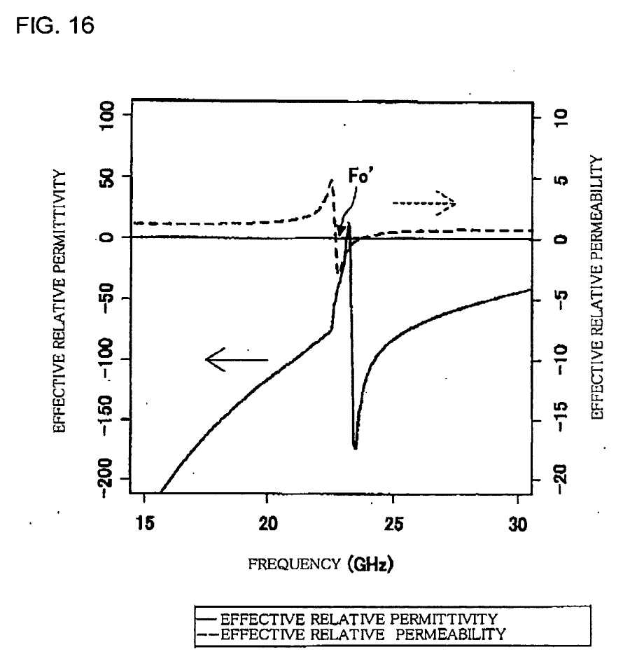

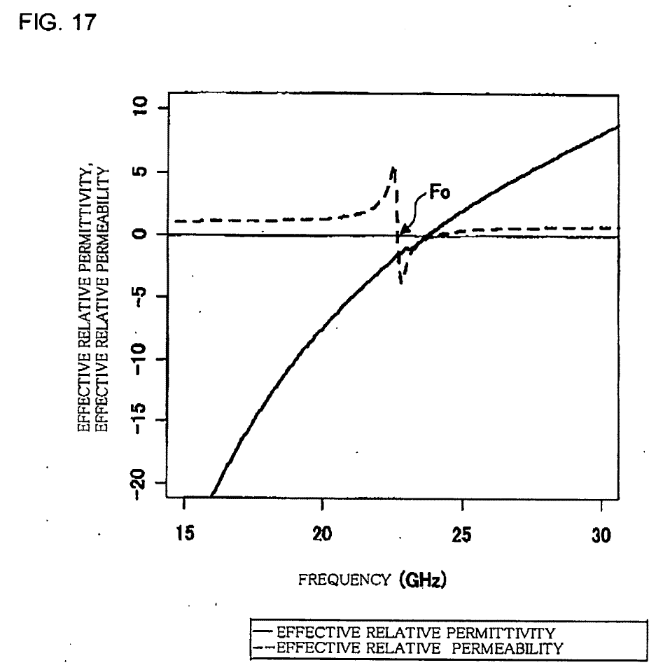

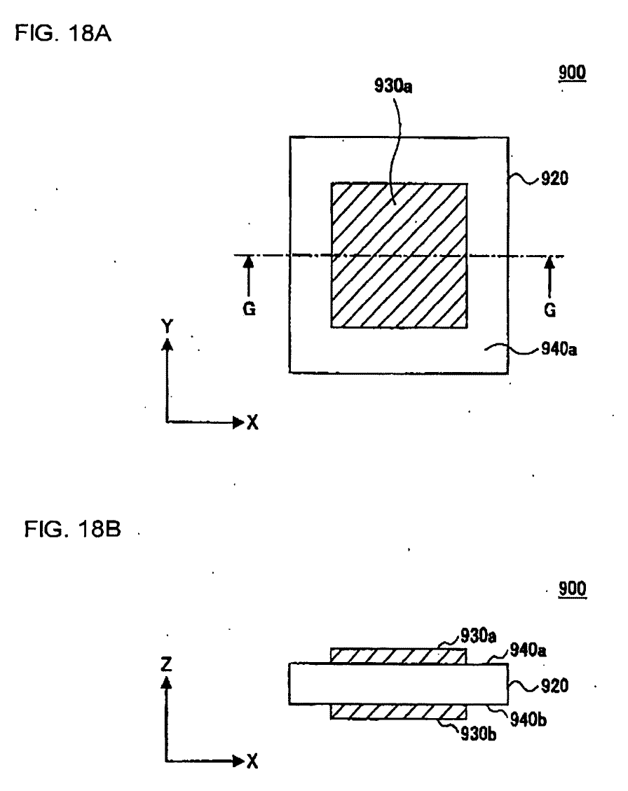

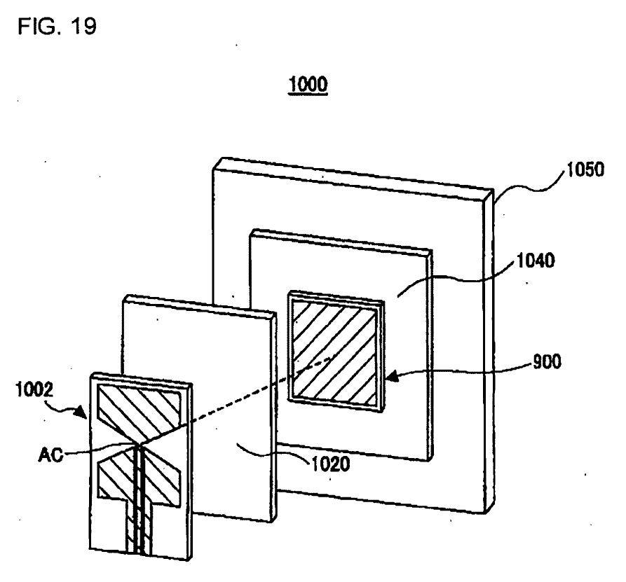

A simulation result of the artificial medium 801W configured as described above is shown in FIG. 16. In addition, the same simulation result as that of the above-mentioned artificial medium 801 is shown in FIG. 17. In the simulation, the finite integration technique (FIT) was used. In addition, the respective parameter values of the artificial mediums 801W and 801 used in the simulation are shown in Table 1. Further, in both the artificial mediums, the number of the laminated layers of the dielectric layers 820 was set to 1. In addition, the thickness of each dielectric layer 820 was set to 0.2 mm, the permittivity of the dielectric layer 111 was set to 4.0, and the dielectric loss was set to 0.001. In addition, the dimensions of each conductive element 830 were set to 3 mm×3 mm, and the thickness was set to 10 μm. Both the widths (d2) of the first and second linear conductor elements 860X and 860Y were set to 2.5 mm, and both the thicknesses were set to 0.2 mm.

TABLE 1

| | P_{X} (mm) | P_{Y} (mm) | P_{A} (mm) | P_{B} (mm) |
|---|---|---|---|---|
| Artificial medium | 9.0 | 9.0 | 9.0 | 9.0 |
| 801 | | | | |
| Artificial medium | 5.125 | 5.125 | 10.25 | 10.25 |
| 801W | | | | |

With reference to FIG. 16, in the artificial medium 801W, it can be seen that the effective relative permittivity (the solid line in the drawing) peaks remarkably in a frequency (about 23 GHZ) in the vicinity of the magnetic resonance frequency Fₒ′ (the frequency between the positive peak and the negative peak of the effective relative permeability, in which the effective relative permeability becomes zero). Besides this, in the artificial medium 801W, the gradient of the effective relative permittivity with respect to the frequency in the frequency band (more specifically, a frequency region from about 23 to about 24 GHz) greater than the frequency Fₒ′ becomes larger compared with the gradient of the effective relative permeability (the broken line in the drawing) with respect to the frequency. On the other hand, in the case of the artificial medium 801, as shown in FIG. 17, in the frequency band (more specifically, a frequency region from about 23 to about 24 GHz) after the magnetic resonance frequency Fₒ, the gradient of the effective relative permittivity (the solid line in the drawing) with respect to the frequency is substantially equal to the gradient of the effective relative permeability (the broken line in the drawing) with respect to the frequency. For matching to the wave impedance Z, it is preferable that the gradient of the effective relative permittivity be close to the gradient of the effective relative permeability with respect to the frequency as much as possible in the frequency band greater than the frequency Fₒ. Therefore, from this point of view, change in the effective relative permittivity as in the artificial medium 801 is more preferable compared with the artificial medium 801W.

Further, in the artificial medium 801W having the so-called “conductive element surrounded by a frame”, even when the respective parameter values (for example, the width d2, the pitches P_{X} and P_{A} of the linear conductor element) are changed, a large peak of the effective relative permittivity as shown in FIG. 16 is similarly confirmed.

As a result, it can be regarded as more preferable that the conductive elements are disposed on the intersections between the first linear conductor elements 860X and the second linear conductor elements 860Y as viewed from a direction parallel to the thickness direction of the artificial medium.

### Third Embodiment

Hereinbefore, the invention has been described as an example of the artificial medium, which is configured such that two or more conductive surfaces are laminated thereon in a thickness direction, and each of which is provided with conductive elements in a two-dimensional periodic array. However, the artificial medium according to the invention is not limited to such a configuration. That is, even with an artificial medium in which a single conductive element is disposed on each conductive surface, the above-mentioned effect can be obtained.

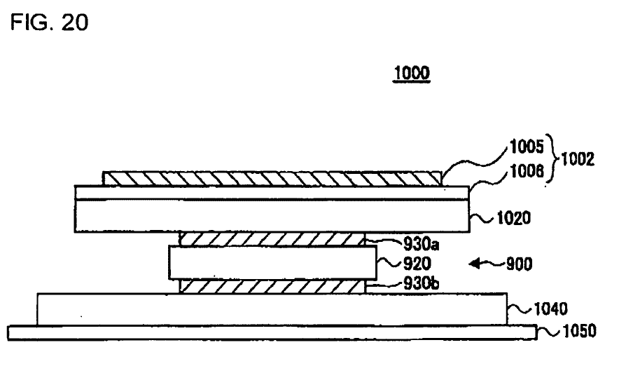

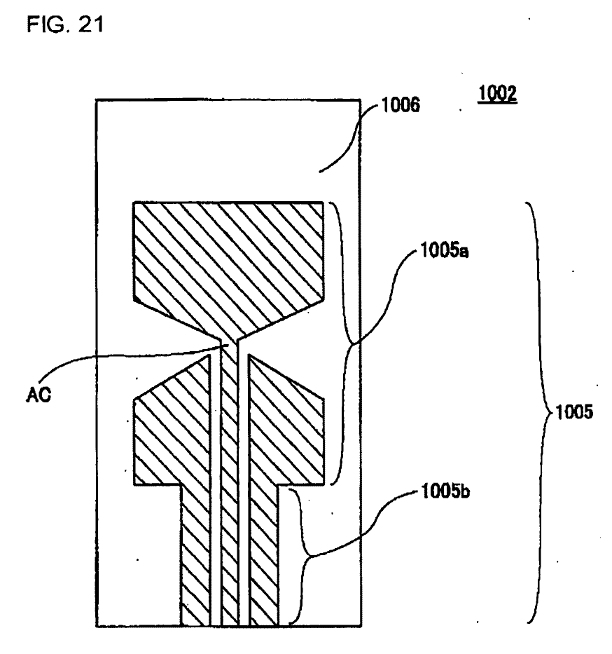

Hereinafter, an example of the artificial medium having the above-mentioned configuration according to the third embodiment of the invention will be described in detail with reference to FIGS. 18A to 20. Here, FIG. 18A is a top view illustrating the artificial medium 900 according to the third embodiment of the invention. FIG. 18B is a cross-sectional view of the artificial medium 900 taken along the line G-G. In addition, FIGS. 19 and 20 show an exploded view and a cross-sectional view schematically illustrating a first antenna device which is provided with the artificial medium 900, respectively.

As shown in FIGS. 18A and 18B, the artificial medium 900 has single conductive elements 930a and 930b in the same dimensional shape on the front and rear surfaces of the dielectric layer 920. Therefore, the front and rear surfaces of the dielectric layer 920 correspond to the conductive surface 940 (940a and 940b). In addition, the conductive elements 930a and 930b are uniformly positioned along the thickness direction (the Z direction) of the artificial medium. Further, in the drawing, the conductive elements 930a and 930b are in a square shape. However, the shape of the conductive element is not limited to the square shape as long as two sides of the shape (and the dimensions) are equal, for example, a rectangular shape, a triangular shape, a polygonal shape, a circular shape, an ellipsoid shape, or the like.

In the artificial medium 900 according to the invention, the sizes of the conductive elements 930a and 930b are adjusted, so that it is possible to adjust a frequency capable of impedance matching. Therefore, the artificial medium 900 configured as described above can be applied to the first antenna device 1000 as shown in FIGS. 19 and 20, for example.

The first antenna device 1000 is constituted by an antenna element 1002, a first spacer layer 1020, the above-mentioned artificial medium 900, a second spacer layer 1040, and a metal plate 1050 which are laminated in this order. As shown with a broken line in FIG. 19, the antenna element 1002 is provided on the upper portion of the artificial medium 900 such that the center portion AC of a radiating element 1005 to be described later is overlapped with the center of the artificial medium 900.

The antenna element 1002 has an antenna substrate 1006 and a conductor 1005 which is provided on the surface of the antenna substrate using a printing method or the like. It is preferable that the antenna substrate 1006 be flexible. The first spacer layer 1020 is constituted by a dielectric body or an insulating body. In order to prevent the conductor 1005 of the antenna element 1002 from being electrically connected with the conductive element 930 (930a) of the artificial medium 900, the first spacer layer 1020 is disposed between the antenna element 1002 and the artificial medium 900. Therefore, when the antenna substrate 1006 of the antenna element 1002 is constituted by a dielectric body or an insulating body, the first spacer layer 1020 may be omitted. Similarly, the second spacer layer 1040 is constituted by a dielectric body or an insulating body. In order to prevent the conductive element 930 (930b) of the artificial medium 900 from being electrically connected with the metal plate 1050, the second spacer layer 1040 is disposed between the two. The conductor 1005, the conductive elements 930a and 930b, and the metal plate may be composed of a conductive material, for example, metal such as copper or aluminum.

FIG. 21 shows a shape of the conductor 1005 of the antenna element 1002. In this embodiment shown in the drawing, the conductor 1005 is constituted by a radiating element 1005a and a feeder 1005b. In this case, in this antenna device, it is matter of course that the shape of the conductor 1005 does not have to be limited to the shape shown in the drawing.

In general, it is known that the characteristics of the antenna device are degraded in a state where another metal is nearby. Therefore, in order to properly operate the antenna device provided with a metal plate in the vicinity thereof, there is a need to interpose a relatively thick layer (for example, the above-mentioned first and second spacer layers) made of a dielectric body or an insulating body between the metal plate and the antenna element. However, when such an interposed thick layer is provided, the antenna device is inhibited from being downsized and having a low profile.

On the contrary, the first antenna device 1000 provided with the artificial medium 900 according to the invention as described above operates properly, even though the metal plate is disposed in the vicinity of the antenna element as described later. This is because the artificial medium according to the invention is interposed between the antenna element and the metal plate, so that the artificial medium and the metal plate serve as in-phase reflector.

Therefore, in the first antenna device 1000 provided with the artificial medium 900 according to the invention, there is no need to provide the interposed thick layer, so that the effect is obtained that the entire device is downsized and has a low profile.

Further, the antenna device is not limited to a broadband antenna, but it should be noted that any antenna device may be employed as long as the antenna device serves to propagate radio waves in space. For example, a dipole antenna, a loop antenna, a linear antenna using a meander line, and slot antenna can be selected. In addition, operating frequencies for operating the antenna device 1000 and/or the artificial medium 900 can be separately selected, so that the antenna device configured as described above can be employed to territorial digital broadcasting, cellular phone, RFID, VICS, ETC, wireless LAN, or the like.

Next, as described above, another example of the application of the artificial medium 900, which is provided with a single conductive element on each conductive surface, will be described.

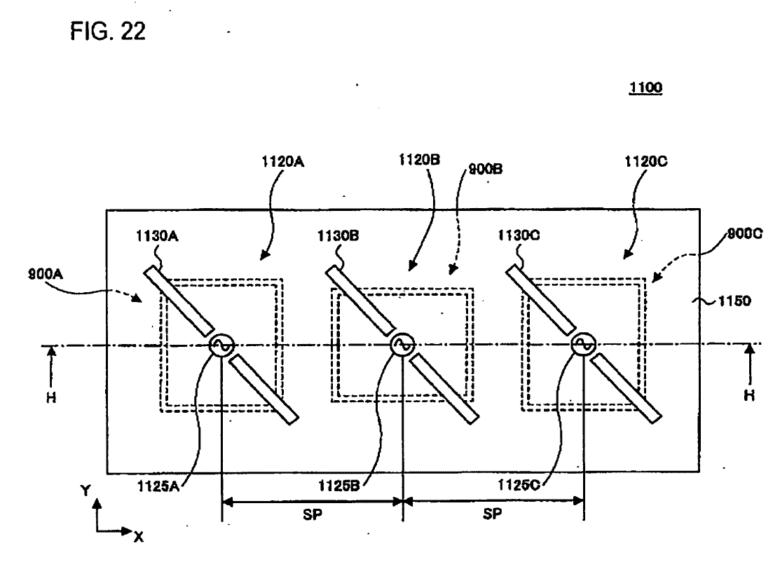

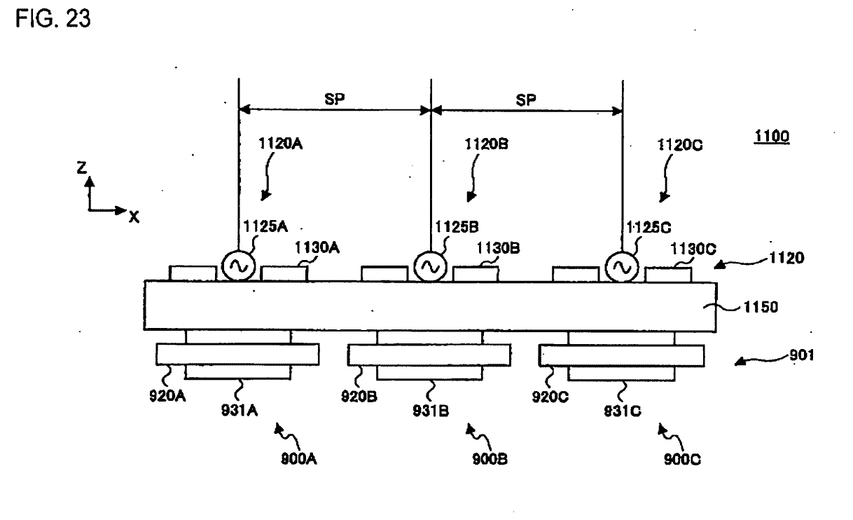

FIGS. 22 and 23 show a top view of the second antenna device constituted by three above-mentioned artificial mediums 900 and s cross-sectional view taken along the line H-H of the antenna device thereof, respectively. The second antenna device 1100 is constituted by an antenna element group 1120 (see FIG. 23), a dielectric substrate 1150, and an artificial medium group 901 (see FIG. 23) which are laminated in this order.

On the upper surface of the dielectric substrate 1150, the antenna element group 1120 is disposed, and on the lower surface of the dielectric substrate 1150, the artificial medium group 901 is disposed.

The antenna element group 1120 has three antenna elements 1120A to 1120C. The respective antenna elements 1120A to 1120C are configured as planar dipole antenna elements, and have power feeding points 1125A to 1125C and conductors 1130A to 1130C. These conductors 1130A to 1130C are disposed on the upper surface (the XY plane) of the dielectric substrate 1150 in a state where the conductors rotate by 45° in the counterclockwise direction with respect to the Y axis.

The artificial medium 901 has first to third artificial mediums 900A, 900B, and 900C. The respective artificial mediums are configured so as to be arranged in a single line along the X direction, so that the conductive surface is formed on the lower surface of the dielectric substrate 1150. Further, these artificial mediums 900A to 900C are similar to the above-mentioned artificial medium 900, and each is configured so as to dispose only one of the same rectangular conductive elements (931A to 931C) on the front and rear surfaces of one of the dielectric layers (920A to 920C).

Here, it should be noted that the first artificial medium 900A and the third artificial medium 900C are disposed such that the longitudinal direction of the conductive elements 931A and 931C is parallel to the Y direction in the drawing, and on the other hand, the second artificial medium 900B is disposed such that the longitudinal direction of the conductive element 931B is parallel to the X direction in the drawing.

Further, when viewed from the upper portion (the Z direction), the above-mentioned respective power feeding points 1125A to 1125C are provided so as to be positioned in the center of the conductive elements 931A to 931C of the respective artificial mediums in the artificial medium group 901.

The antenna device 1100 (hereinafter, referred to as “the second antenna device according to the invention”) configured as described above has the following characteristics compared with the similar antenna device (for example, referred to as “the generic antenna device”) without the artificial medium group 901.

In the case of the generic antenna device, the magnetic field of the electromagnetic wave obtained from the respective antenna elements 1120A to 1120C is generated in a direction along the conductor 1130, that is, forms a tilted angle by 45° in the counterclockwise direction from the Y direction in FIG. 22. This is the same for any antenna element. In this case, when a space SP between the power feeding points 1125 is too narrow, the electromagnetic wave of the adjacent antenna element is coupled with, so that the space SP cannot be narrowed very much. Therefore, it is difficult to downsize the generic antenna device.

On the contrary, in the second antenna device 1100 according to the invention, the magnetic field direction of the electromagnetic wave obtained from the respective antenna elements is affected by the artificial medium group 901. In particular, in the antenna element 1120B positioned in the center, the direction of the conductive element of the second artificial medium 900B is shifted tilted by 90° with respect to both the adjacent artificial mediums 900A and 900C, so that the magnetic field direction of the electromagnetic wave obtained by the antenna element 1120B is perpendicular to the magnetic field direction of the electromagnetic wave of both the antenna elements 1120A and 1120C. For this reason, in the second antenna device 1100 according to the invention, the space between the power feeding points can be narrowed, that is, the space between the adjacent antenna elements can be narrowed.

Therefore, it is possible for the second antenna device according to the invention to be downsized and integrated compared with the antenna device according to the related art.

Further, in the above-mentioned third embodiment, the configuration of the invention has been described as an example of the artificial medium which is constituted by two conductive surfaces each having a single element. However, in the third artificial medium as described above, it will be apparent to those skilled in the art that the artificial medium may have three or more conductive surfaces along the thickness direction.

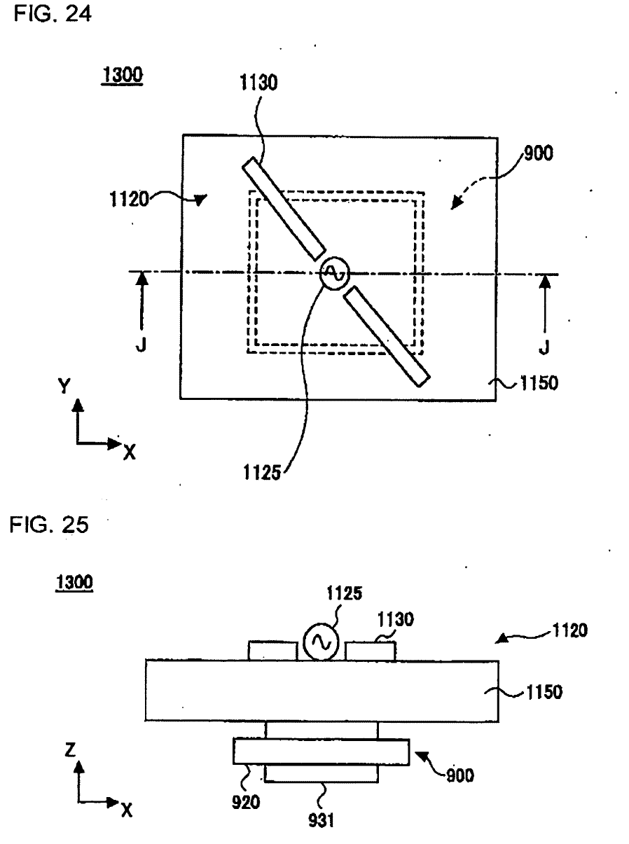

Next, with reference to FIGS. 24 and 25, an example of the third antenna device provided with the artificial medium 900 in FIGS. 18A and 183 will be described. Here, FIG. 24 is a top view schematically illustrating the third antenna device 1300 according to the invention. FIG. 25 is a cross-sectional view taken along the line J-J schematically illustrating the third antenna device 1300. Further, in the respective elements constituting the antenna device 1300, the same elements as those in the above-mentioned antenna device 1100 are designated by the same reference numerals.

Similar to the above-mentioned second antenna device 1100, the third antenna device 1300 is configured by using the above-mentioned artificial medium 900 In this case, in the antenna device 1300, only one artificial medium 900 is used. That is, the third antenna device 1300 is constituted by the antenna element 1120, the dielectric substrate 1150, and the artificial medium 900 which are laminated in this order.

The antenna element 1120 is configured as a planar dipole antenna, and has the power feeding point 1125 and the conductor 1130. The conductor 1130 is disposed on the upper surface (the XY plane) of the dielectric substrate 1150 so as to rotate by 45° in the counterclockwise direction with respect to the Y axis.

The artificial medium 900 is equal to the artificial medium 900 which is used in the above-mentioned second antenna device 1100, which is configured such that the conductive elements 931 in the same rectangular shape are disposed on the front and rear surfaces of one dielectric layer 920 one by one.

Here, when viewed from the upper portion (the Z direction), the above-mentioned power feeding point 1125 is provided so as to be positioned in the center of the conductive element 931 of the artificial medium 900.

The third antenna device 1300 configured as described above has the characteristics of multiple resonance and operation in a broadband compared with the similar antenna device without the artificial medium 900 as described later.

Hereinafter, examples according to the invention will be described.

### Example 1

The artificial medium according to the invention is produced in the following sequence by way of trial, and the characteristics of the obtained artificial medium are evaluated.

First, using the FR4 (Flame Retardant Grade-4) which is a material for a general printed circuit board and a process of a general multilayer printed circuit board, the artificial medium with a side of 150 mm is produced by a trial. The conductive elements are disposed on both surfaces of a core layer with a thickness of 0.2 mm, and a copper foil with a thickness of 18 μm was used as the conductor. The conductive element is in a square shape with a side Q of 3 mm, and the space G between the conductive elements in the surface is 1 mm. The distance GS from an end of four sides of the artificial medium to the conductive element nearest thereto is set to 1.5 mm, and 37 conductive elements are disposed lengthwise and crosswise.

Next, two core layers in which an arrangement pattern of the conductive element is formed on the front and rear surfaces are laminated in a state where the isometric prepreg layer (that is, length 150 mm×width 150 mm×thickness 0.2 mm) without a conductive element is interposed therebetween. In addition, the laminated structure is heated at 170° C. or more in a state where the laminated structure is uniformly pressed (about 2 to 3 MPa) from the laminating direction, and the prepreg layer is melted, so that 3 layers are bonded, and the artificial medium is manufactured. The temperature increase rate of the laminated structure is set to about 1.5 to 3.5° C./min, and the laminated structure is held at 170° C. or less for at least 20 minutes. Further, the thermal treatment of the laminated structure is implemented under a vacuum atmosphere with a vacuum degree of 4.0 kPa.

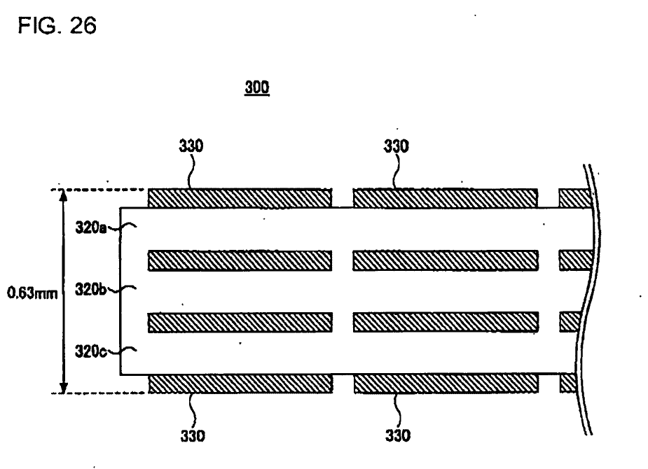

The obtained artificial medium 300 includes 3 layers of dielectric layer portions 320a to 320c as schematically shown in the cross-sectional view of FIG. 26. Between these dielectric layer portions and on both the outermost surfaces of the artificial medium 300, patterns of the conductive elements 330 are disposed, 4 layers of the conductive surfaces in total are configured. In addition, the final thickness T of the artificial medium 300 becomes 0.63 mm, which is called the artificial medium according to Example 1.

Next, using the artificial medium according to Example 1 manufactured as described above, the effective relative permittivity and the effective relative permeability generated in the artificial medium are measured when the electromagnetic wave propagated in a direction parallel to the laminating direction of the substrates is incident thereon.

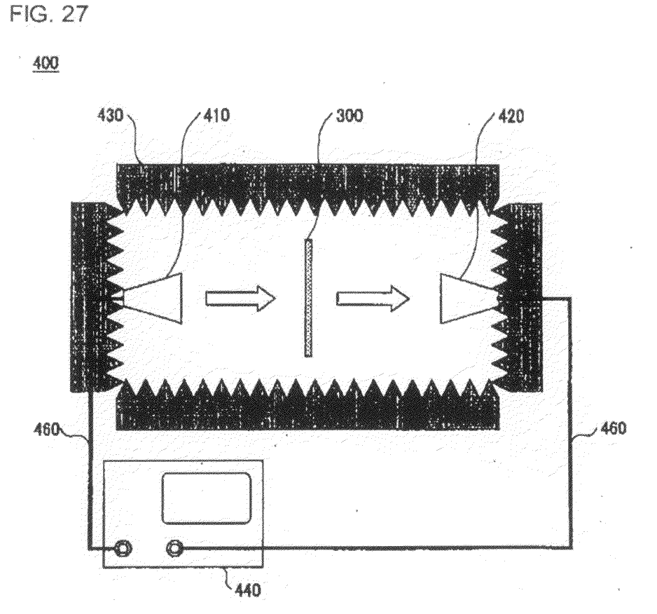

FIG. 27 schematically shows a configuration of a measurement device for measuring the effective relative permittivity and the effective relative permeability of the artificial medium. The measurement device 400 has a transmitting horn antenna 410, a receiving horn antenna 420, a radio wave absorber 430, and a vector network analyzer 440. The artificial medium 300 as a measuring target manufactured as described above is provided between the transmitting horn antenna 410 and the receiving horn antenna 420. The entire measurement region from the transmitting horn antenna 410 to the receiving horn antenna 420 is covered with the radio wave absorber 430. In addition, the vector network analyzer 440 is connected to the transmitting horn antenna 410 and the receiving horn antenna 420 via a coaxial cable 460. In this measurement, as the transmitting horn antenna 410 and the receiving horn antenna 420, conical horn antennas are used. The distance from the transmitting horn antenna 410 to the receiving horn antenna 420 is set to 320.6 mm, and the distance from these antennas 410 and 420 to the artificial medium 300 is set to 160 mm.

Using such a measurement device 400, the effective relative permittivity and the effective relative permeability of the artificial medium according to Example 1 are obtained as the following. First, using the vector network analyzer 440, S parameters of the artificial medium 300 are measured by a free space method. Next, from the obtained result, using the calculation algorithms described in the following documents (1) to (3), the effective relative permittivity and the effective relative permeability of the artificial medium 300 according to Example 1 are calculated:

(1) A. M. Nicolson, G. F. Ross, “Measurement of the Intrinsic Properties of Materials by Time Domain Techniques”, IEEE Transaction on IM. No. 4, November 1970

(2) W. B. Weir, “Automatic Measurement of Complex Dielectric Constant and Permeability at Microwave Frequencies”, Proc. of IEEE, Vol. 62, January 1974

(3) J. B. Jarvis, E. J. Vanzura, “Improved Technique for Determining Complex Permittivity with the Transmission/Reflection Method”, IEEE Transaction MTT, vol. 38, August 1990.

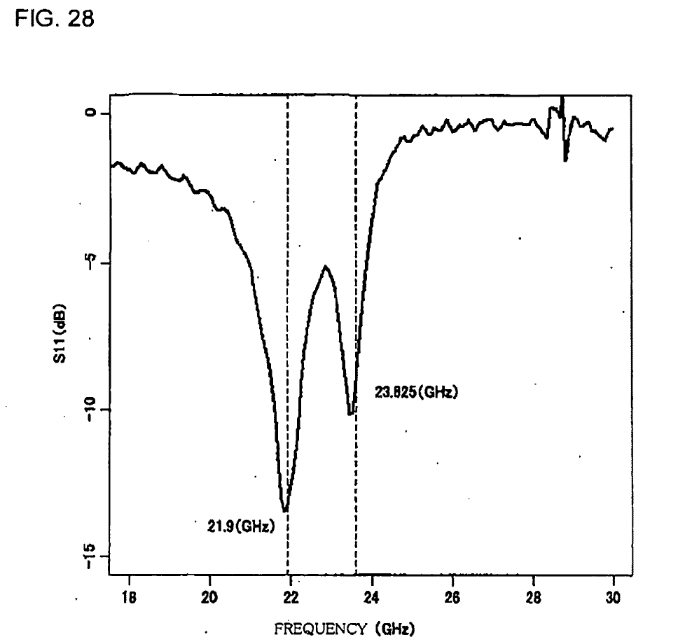

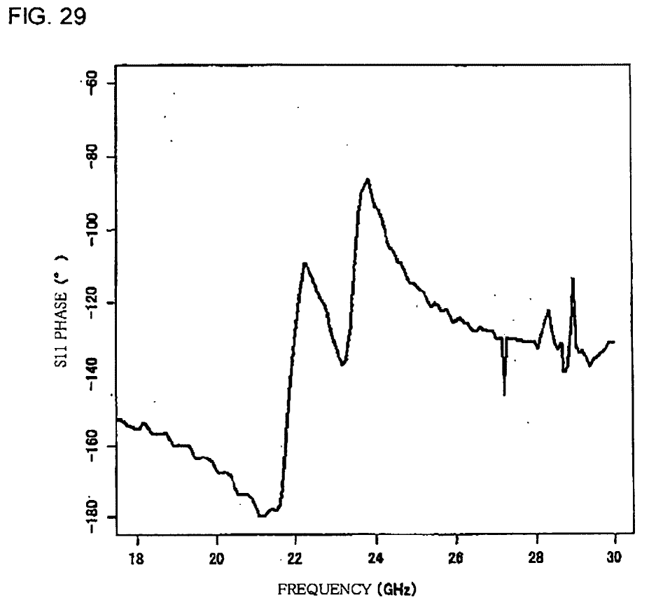

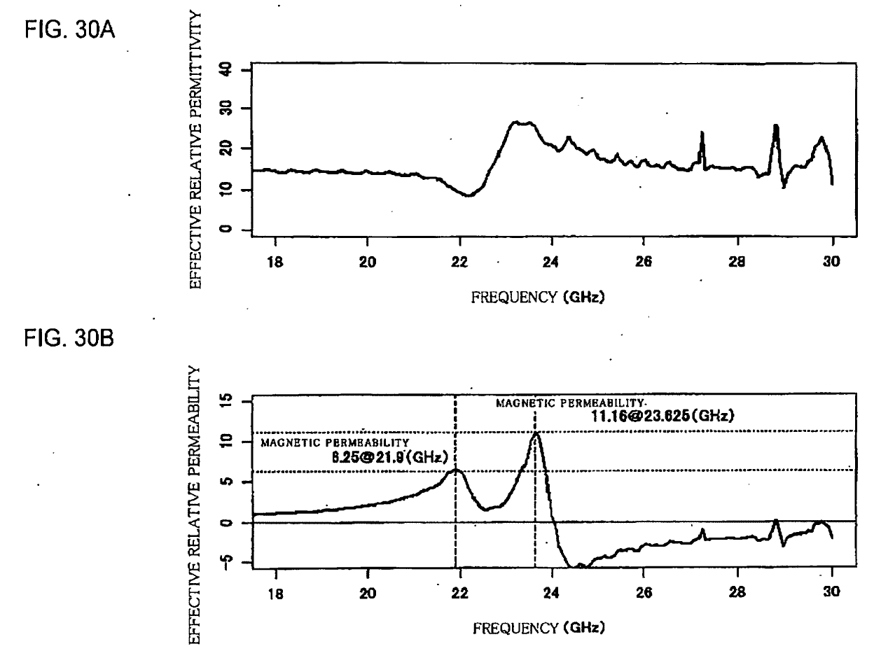

FIG. 28 shows the amplitude characteristics of the S parameter (S11) of the artificial medium according to Example 1, which are obtained by measurement using the above-mentioned device 400. In addition, FIG. 29 shows the measurement result of the phase characteristics of the S parameter (S11) of the artificial medium according to Example 1. Furthermore, FIGS. 30A and 30B show the frequency characteristics of the effective relative permittivity (upper part) and the effective relative permeability of the artificial medium according to Example 1, which are calculated by the above-mentioned calculation algorithms using these results. With reference to FIGS. 30A and 30B, it can be seen that the effective relative permeability of the artificial medium according to Example 1 increases as the frequency increases, and thus a local maximum value (6.25) is obtained at 21.9 GHz, and a maximum value (11.16) is obtained at 23.625 GHz. In addition, from the result of the amplitude characteristics of the S parameter in FIG. 28, it can be seen that the artificial medium is matched at frequencies of 21.9 GHz and 23.625 GHz at which the effective relative permeability is a peak value.

### Example 2

Next, assuming an artificial medium (hereinafter, referred to as “the artificial medium according to Example 2”) constituted by two layers of the dielectric layers and three layers (between the conductive layers and the outermost surfaces of both surfaces of the artificial medium) of the conductive surfaces, the obtained characteristics are predicted by simulation.

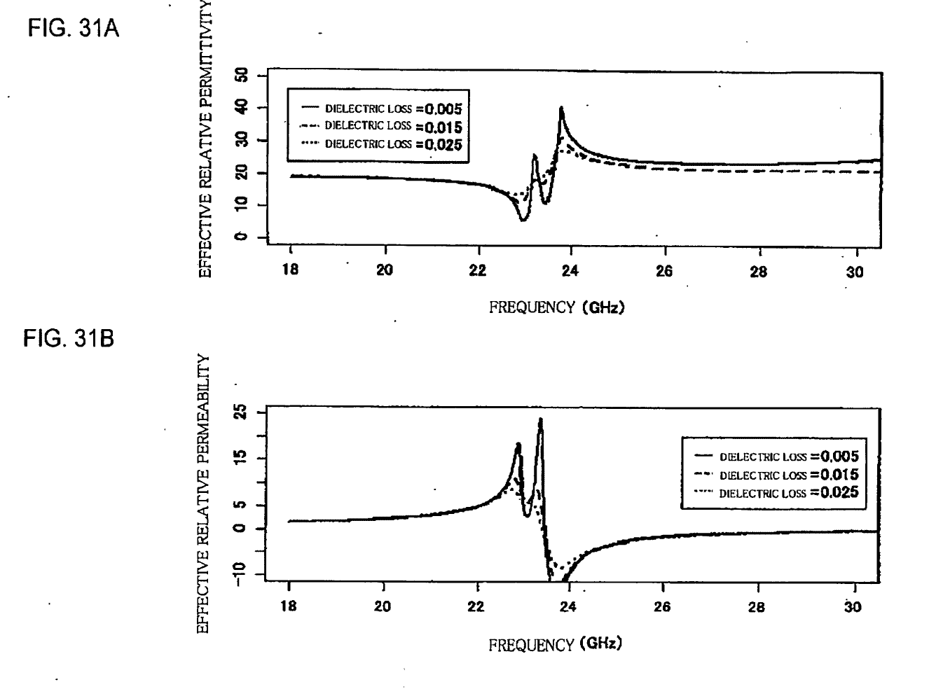

FIGS. 31A and 31B show the simulation results of the effective relative permittivity and the effective relative permeability, which are obtained in the artificial medium according to Example 2. Further, in the calculation, a three-dimensional electromagnetic field simulation by FIT (Finite Integration Technique) is used. In addition, the calculation is carried out on the conductive layer between the layers by setting the permittivity to 4.2 and the dielectric loss to three types of 0.005, 0.015, and 0.025. With reference to FIGS. 31A and 31B, it can be seen that when the dielectric loss is set to 0.005, the peak value of the effective relative permeability at a frequency of 22.8 GHz is larger compared with when the dielectric loss is set to 0.025.

As a result, a material with low dielectric loss is used as the dielectric layer, so that the peak value of the effective relative permeability can be increased. For example, a fluororesin-based resin material such as RT/Duroid 5880 (permittivity is 2.2, and dielectric loss is 0.0009) made by ROGERS, Co. or RO 3003 (permittivity is 3.0, and dielectric loss is 0.0013) made by ROGERS, Co. may be used. As a result, it is considered that the peak value of the effective relative permeability can be increased.

### Example 3

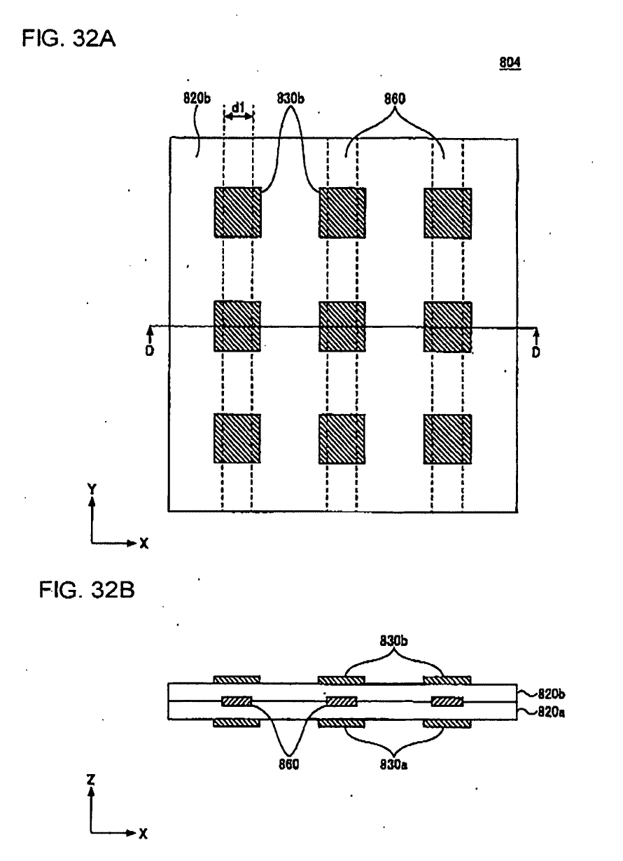

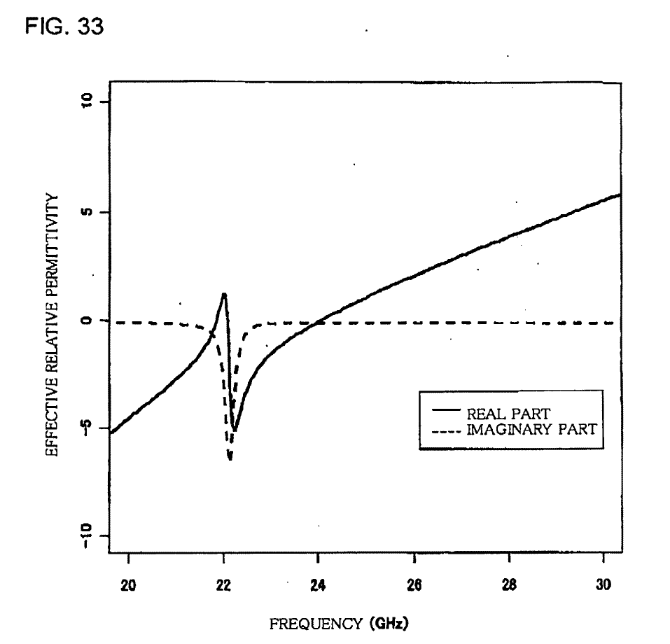

Next, assuming an artificial medium (hereinafter, referred to as “the artificial medium 804 according to Example 3”) constituted by the conductive elements and the linear conductor elements as shown in FIGS. 32A and 32B, the characteristics are predicted using the same simulation as that of Example 2. Further, FIG. 32B is a cross-sectional view taken along the line D-D in FIG. 32A. Here, the artificial medium 804 according to Example 3 is assumed to be configured as described in the following. That is, it is assumed that the artificial medium 804 is constituted by a pattern of the conductive elements 860 disposed between a first dielectric layer 820a and a second dielectric layer 820b, a pattern of the conductive elements 830a disposed on the lower side of the first conductive layer 820a, a pattern of the conductive elements 830a disposed on the upper surface of the second dielectric layer 820b. In addition, the respective parameters of the artificial medium according to Example 3 are set as shown in Table 2. Further, the relative permittivity of the dielectric layer is 4.0, and the dielectric loss is 0.01. In addition, the conductivity of the conductive element and the linear conductor element is 6.29×10⁷ S/m.

TABLE 2

| | CONDUCTIVE ELEMENT (830a, 830b) | | | | | | |
|---|---|---|---|---|---|---|---|
| | | WIDTH Q | | | | | |
| | | (X | | LINEAR CONDUCTOR | | | THICKNESS OF |
| | | DIRECTION:Y | | ELEMENT (860) | | | DIELECTRIC |
| | PITCH P | DIRECTION) | THICKNESS | PITCH | WIDTH d1 | THICKNESS | LAYER |
| Example 3 | 10 mm | 3 mm × 3 mm | 10 μm | 10 mm | 2.5 mm | 10 μm | 0.1 mm × 2 |
| | | | | | | | layers |

As can be seen from the Table, the length Q of each one side of the conductive elements 830a and 830b is greater than the width d1 of the linear conductor element 860 to some degree.

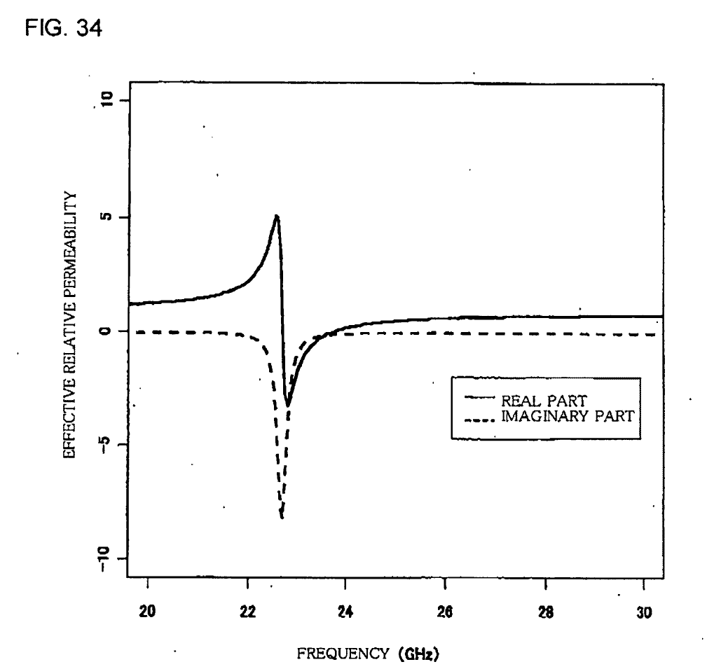

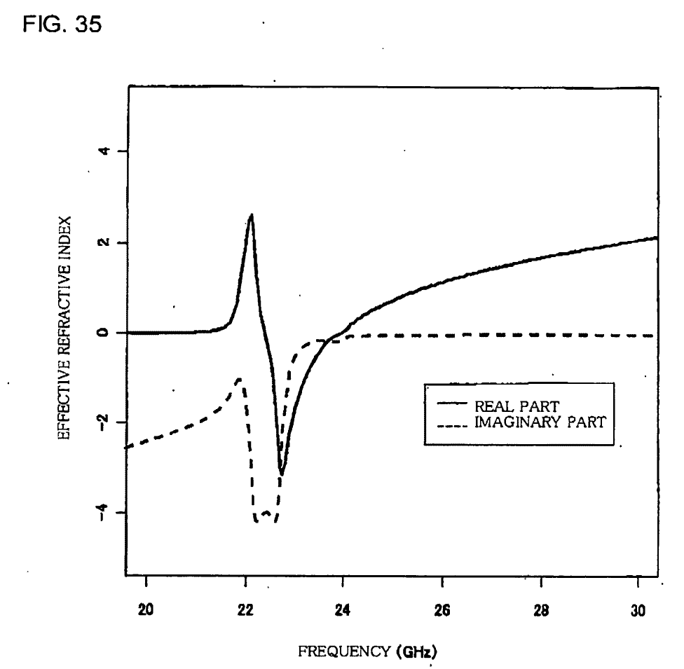

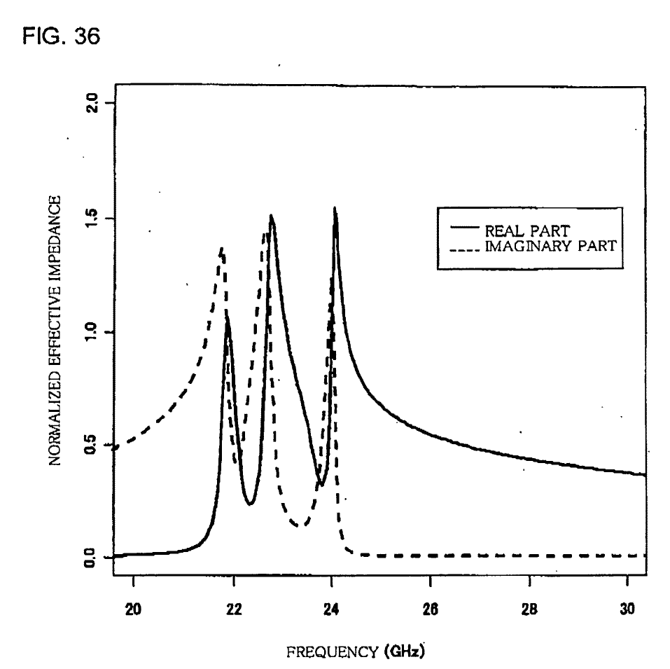

FIGS. 33 to 36 show the simulation results. Further, the magnetic field direction of the electromagnetic wave incident on the medium is parallel to the X direction in FIGS. 32A and 32B, and the electric field direction thereof is parallel to the Y direction. FIG. 33 shows frequency dependence of the effective relative permittivity of the artificial medium 804 according to Example 3. With reference to the drawing, it can be seen that there is a region in which a real part of the effective relative permittivity becomes a negative value in the vicinity of frequencies from 22 GHz to 24 GHz. In addition, FIG. 34 shows the frequency dependence of the effective relative permeability of the artificial medium 804 according to Example 3. With reference to the drawing, it can be seen that there is a region in which a real part of the effective relative permeability becomes a negative value in the same region (in the vicinity of frequencies from 22 to 24 GHz). Furthermore, FIG. 35 shows the frequency dependence of the effective refractive index. With reference to the drawing, it can be seen that the so-called left handed metamaterial is obtained of which the refractive index becomes a negative value in the vicinity of frequencies from 22 to 24 GHz. In addition, FIG. 36 shows the frequency dependence of the normalized effective impedance (that is, a ratio of impedance of the medium to impedance in the free space). In the above-mentioned frequency region, the normalized effective impedance shows a value of approximately 1. The result shows that the artificial medium according to the invention can exhibit good characteristics as the left handed metamaterial.

### Example 4

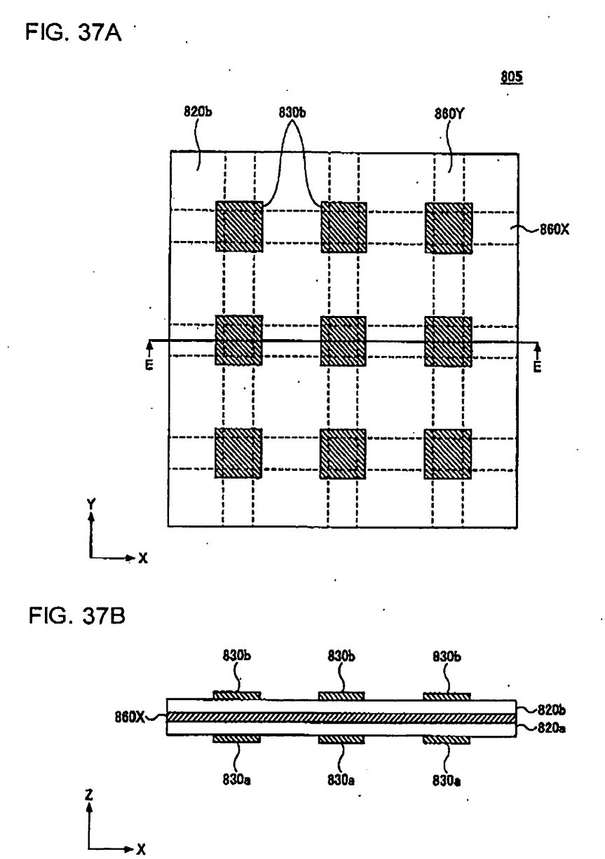

Next, assuming an artificial medium (hereinafter, referred to as “the artificial medium 805 according to Example 4”) constituted by the conductive elements and the linear conductor elements as shown in FIGS. 37A and 37B, the characteristics are predicted using the same simulation as that of Example 2. Further, FIG. 37B is a cross-sectional view taken along the line E-E in FIG. 37A. The artificial medium 805 according to Example 4 is assumed to be configured similar to the artificial medium 804 according to Example 3 as described above. In this case, Example 4 is different in that the linear conductor elements 860X and 860Y are provided between the first dielectric layer 820a and the second dielectric layer 820b The linear conductor elements 860X extend in the X direction in the drawing, and the linear conductor elements 860Y extend in the Y direction in the drawing. The respective parameters of the artificial medium according to Example 4 are set as shown in Table 3. Further, the relative permittivity of the dielectric layer is 4.0, and the dielectric loss is 0.01. In addition, the conductivity of the conductive element and the linear conductor element is 6.29×10⁷ S/m.

TABLE 3

| | CONDUCTIVE ELEMENT (830a, 830b) | | | | | | |
|---|---|---|---|---|---|---|---|
| | | WIDTH Q | | LINEAR CONDUCTOR | | | THICKNESS OF |
| | | (X DIRECTION:Y | | ELEMENT (860X, 860Y) | | | DIELECTRIC |
| | PITCH P | DIRECTION) | THICKNESS | PITCH | WIDTH d1, d2 | THICKNESS | LAYER |
| Example 4 | 9 mm | 3 mm × 3 mm | 10 μm | 9 mm | 2.5 mm | 10 μm | 0.1 mm × 2 |
| | | | | | | | layers |

As can be seen from the Table, the length Q of each one side of the conductive elements 830a and 830b is slightly greater than the widths d1 and d2 of the linear conductor elements 860X and 860Y.

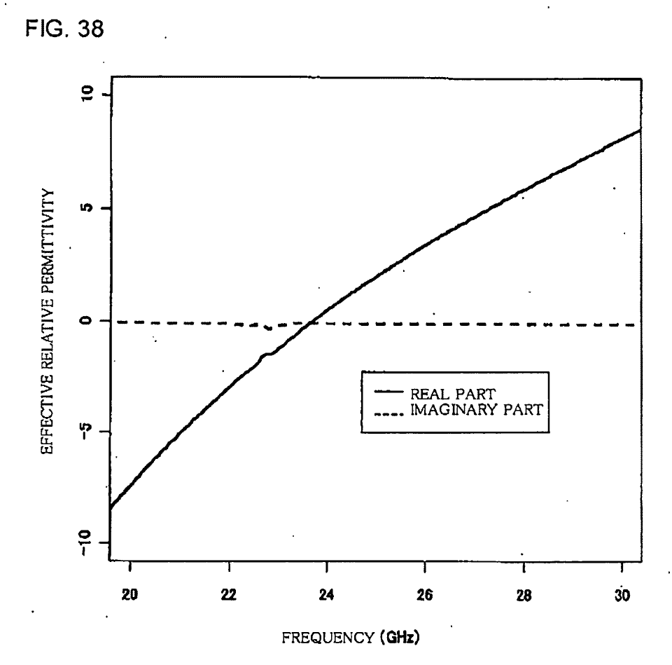

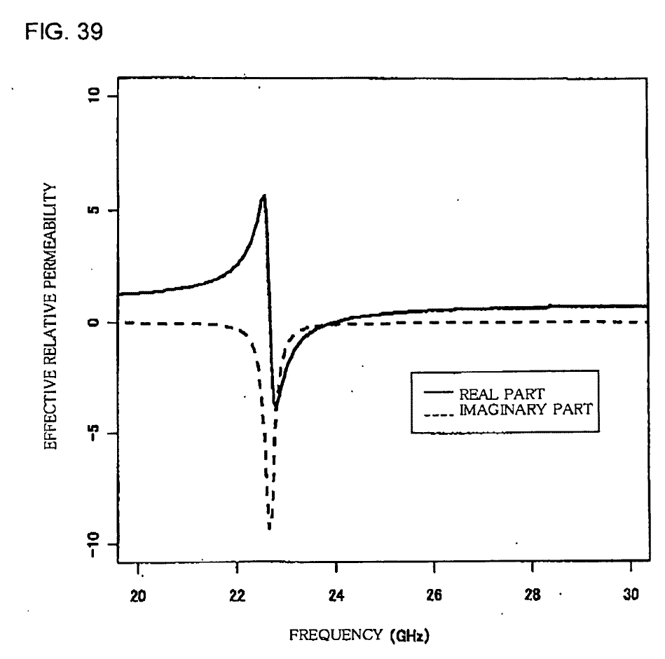

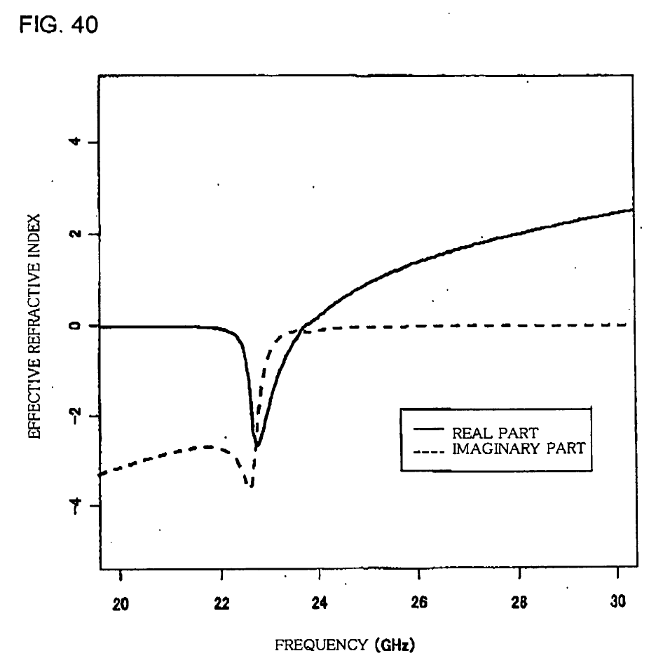

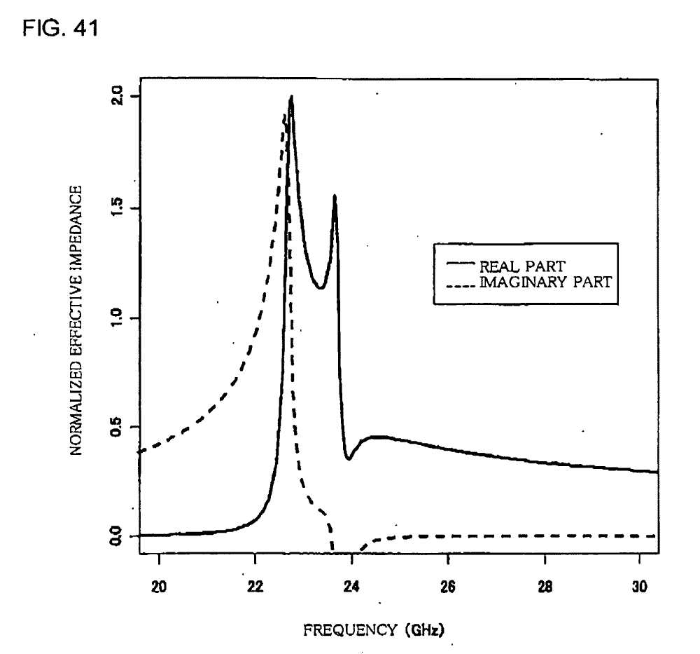

FIGS. 38 to 41 show the simulation results. FIG. 38 shows frequency dependence of the effective relative permittivity of the artificial medium 805 according to Example 4. With reference to the drawing, it can be seen that there is a region in which a real part of the effective relative permittivity becomes a negative value in a frequency region equal to or less than 24 GHz. In addition, FIG. 39 shows the frequency dependence of the effective relative permeability of the artificial medium 805 according to Example 4. With reference to the drawing, it can be seen that there is a region in which a real part of the effective relative permeability becomes a negative value in a frequency region from 23 GHz to 24 GHz. Furthermore, FIG. 40 shows the frequency dependence of the effective refractive index. With reference to the drawing, it can be seen that the so-called left handed metamaterial is obtained of which the refractive index becomes a negative value in a frequency region from 22 GHz to 24 GHz. In addition, FIG. 41 shows the frequency dependence of the normalized effective impedance (that is, a ratio of impedance of the medium to impedance in the free space). In the above-mentioned frequency region from 22 GHz to 24 GHz, the normalized effective impedance shows a value of approximately 1. The result shows that the artificial medium according to the invention can exhibit good characteristics as the left handed metamaterial.

### Example 5

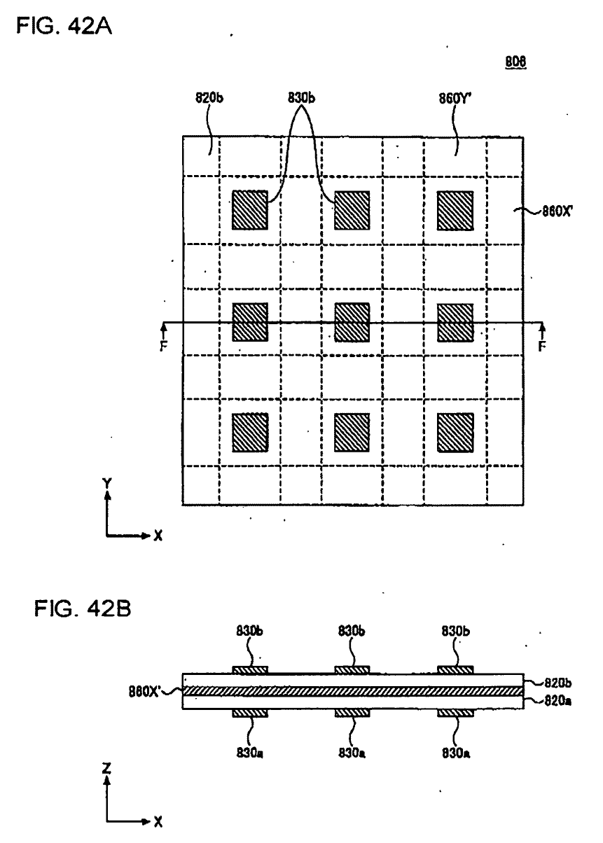

Next, assuming an artificial medium (hereinafter, referred to as “the artificial medium 806 according to Example 5”) constituted by the conductive elements and the linear conductor elements as shown in FIGS. 42A and 42B, the characteristics are predicted using the same simulation as that of Example 2. Further, FIG. 42B is a cross-sectional view taken along the line F-F in FIG. 42A. The artificial medium 805 according to Example 5 is assumed to be configured similar to the artificial medium 805 according to Example 4 as described above. In this case, Example 5 is different from Example 4 in that the length Q of each one side of the conductive elements 830a and 830b is smaller than the widths d1 and d2 of the linear conductor elements 860X′ and 860Y′. The respective parameters of the artificial medium according to Example 5 are set as shown in Table 4. Further, the relative permittivity of the dielectric layer is 4.0, and the dielectric loss is 0.01. In addition, the conductivity of the conductive element and the linear conductor element is 6.29×10⁷ S/m.

TABLE 4

| | CONDUCTIVE ELEMENT (830a, 830b) | | | | | | |
|---|---|---|---|---|---|---|---|
| | | WIDTH Q | | LINEAR CONDUCTOR | | | THICKNESS OF |
| | | (X DIRECTION:Y | | ELEMENT (860X′, 860Y′) | | | DIELECTRIC |
| | PITCH P | DIRECTION) | THICKNESS | PITCH | WIDTH d1, d2 | THICKNESS | LAYER |
| Example 5 | 7.5 mm | 2.5 mm × 2.5 mm | 10 μm | 7.5 mm | 4.5 mm | 10 μm | 0.491 mm × 2 |
| | | | | | | | layers |

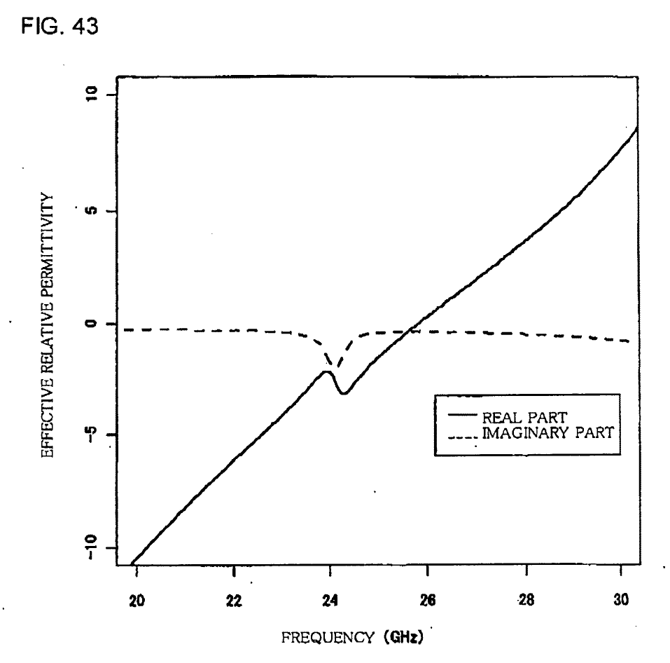

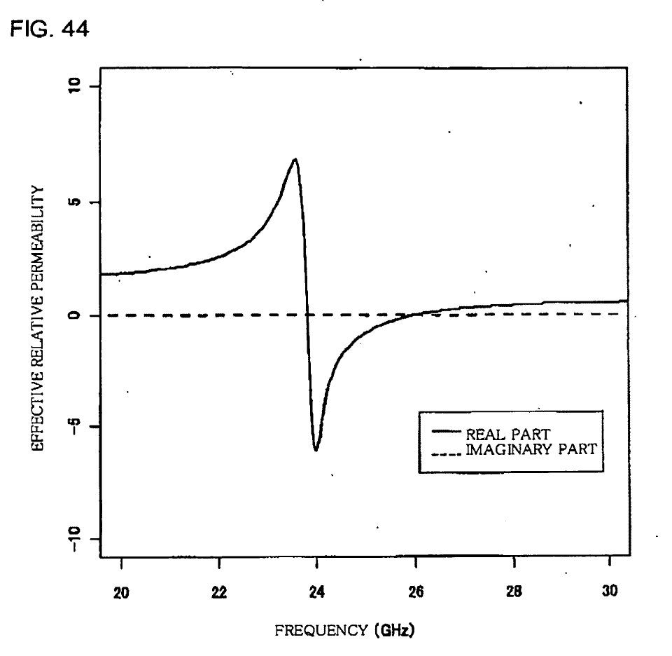

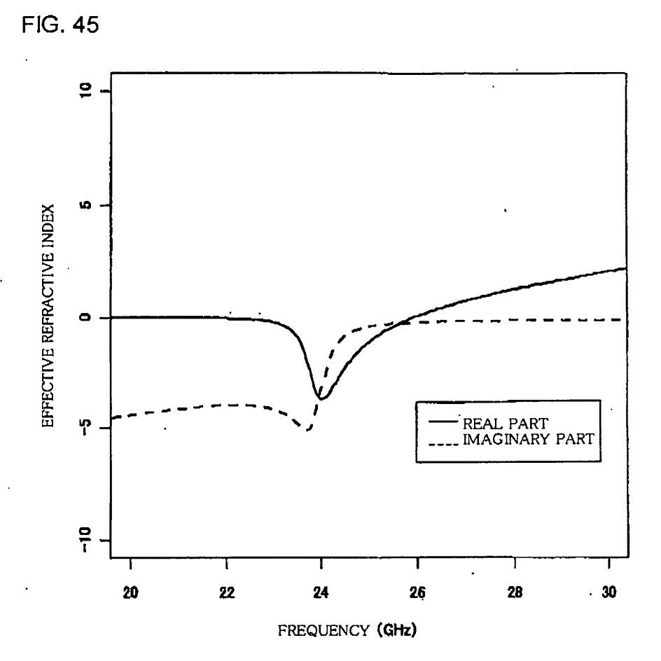

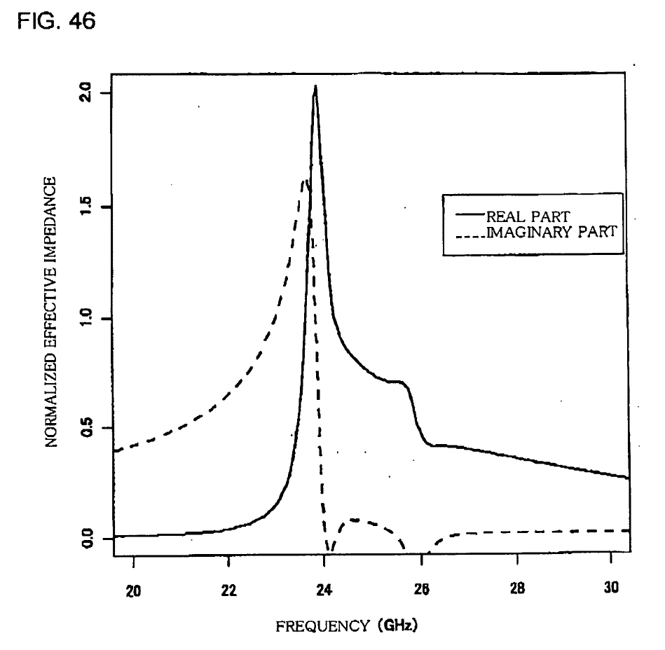

FIGS. 43 to 46 show the simulation results. FIG. 43 shows frequency dependence of the effective relative permittivity of the artificial medium 806 according to Example 5. With reference to the drawing, it can be seen that there is a region in which a real part of the effective relative permittivity becomes a negative value in a frequency region of around 24 GHz. In addition, FIG. 44 shows the frequency dependence of the effective relative permeability of the artificial medium 806 according to Example 5. With reference to the drawing, it can be seen that there is a region in which a real part of the effective relative permeability becomes a negative value in a frequency region from 24 GHz to 26 GHz. Furthermore, FIG. 45 shows the frequency dependence of the effective refractive index. With reference to the drawing, it can be seen that the so-called left handed metamaterial is obtained of which the effective refractive index becomes a negative value in a frequency region from 23 GHz to 25 GHz. In addition, FIG. 46 shows the frequency dependence of the normalized effective impedance (that is, a ratio of impedance of the medium to impedance in the free space). In the above-mentioned frequency region of around 24 GHz, the normalized effective impedance shows a value of approximately 1. The result shows that the artificial medium according to the invention can exhibit good characteristics as the left handed metamaterial.

In the present application, specific examples of manufacturing the artificial mediums (that is, the artificial mediums having the linear conductor element) configured as shown in FIGS. 32A, 32B, 37A, 37B, 42A and 42B are not shown, but it will be apparent to those skilled in the art that the artificial mediums can also be easily manufactured using the same technique as that in Example 1, that is, an FR4 which is a material for a general printed circuit board and a process for a general multilayer printed circuit board. In this case, after a pattern of the linear conductor elements on the upper portion of one dielectric layer, there is added a step of covering the upper portion with another dielectric layer.

### Example 6

Next, the antenna device (the antenna device shown in FIGS. 19 to 21) which is provided with the artificial medium according to the above-mentioned third embodiment is produced as a trial, and the characteristics are evaluated. The antenna device is manufactured as the following.

(Manufacturing the Artificial Medium)

The single conductive element 930 (930a and 930b) is printed on each of the front and rear surfaces of the dielectric layer 920, and the artificial medium 900 (see FIGS. 18A and 18B) in which both surfaces serve as the conductive surfaces 940 is manufactured.

The dimensional shape of the dielectric layer 920 is a rectangular shape of 100 mm×100 mm (a thickness of 0.762 mm). In addition, the dimensional shape of the conductive elements 930a and 930b is a rectangular shape of 90 mm×90 mm, and these elements are disposed on the approximate centers of the front and rear surfaces of the dielectric layer so as to be uniformly positioned in the thickness direction. As the dielectric layer 920, thermosetting resin (with relative permittivity of 3.38) is used, and as the conductive elements 930a and 930b, copper is used.

(Manufacturing the Antenna Device)

The antenna element 1002 is manufactured by printing copper as the conductor 1005 on a flexible board 1006 (length of 245 mm×width of 110 mm) made of polyimide.

Next, the antenna element 1002 is laminated on the above-mentioned artificial medium 900 via the first spacer layer 1020 (length of 275 mm×width of 130 mm, thickness of 0.762 mm). In addition, the metal plate 1050 (length of 300 mm×width of 300 mm, thickness of 3 mm) is disposed under the artificial medium 900 via the second spacer layer 1040 (length of 220 mm×width of 220 mm, thickness of 0.762 mm), and the antenna device (the antenna device according to Example 6) is manufactured. As the first spacer layer 1020 and the second spacer layer 1040, thermosetting resin which has a relative permittivity of 3.38 and a thickness of 0.762 mm is used.

Further, as shown in FIG. 21, the above-mentioned conductor 1005 is manufactured in a shape in which the radiating element 1005a and the feeder 1005b are included. In this case, the radiating element 1005a is supplied with the electric power by a coplanar wave guide of the feeder. The dimensional shape of the radiating element 1005a (refer to the shape of the radiating element 1005a shown in FIG. 21) is set to a length of 142 mm×width of 99 mm. The impedance of the feeder 1005b is 50Ω.

(Characteristics Evaluation)

The characteristics of the antenna device manufactured as described above are evaluated. The antenna characteristics are evaluated by measuring the return loss (S11 characteristics) using the above-mentioned vector network analyzer.

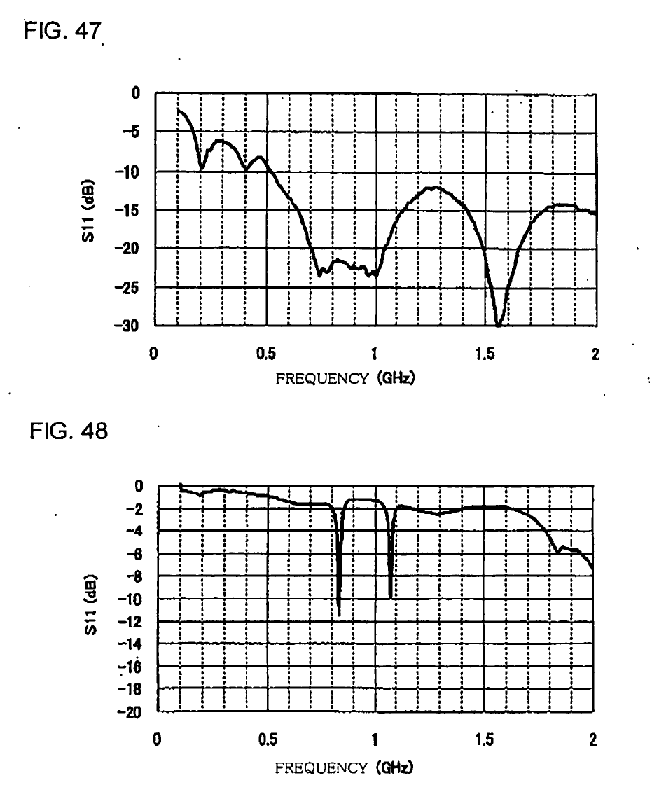

FIG. 47 shows the S11 characteristics which are obtained when the above-mentioned antenna element 1002 is single. The S11 value is less than −10 dB from the vicinity of a frequency of 500 MHz, and it can be seen that the antenna device operates properly as a broadband antenna.

FIG. 48 shows the same measurement result as that of the antenna device according to Example 6. With reference to the result, in the antenna device according to Example 6, it can be seen that the impedance is matched in frequencies of about 835 MHz and about 1070 MHz.

### Comparative Example 1

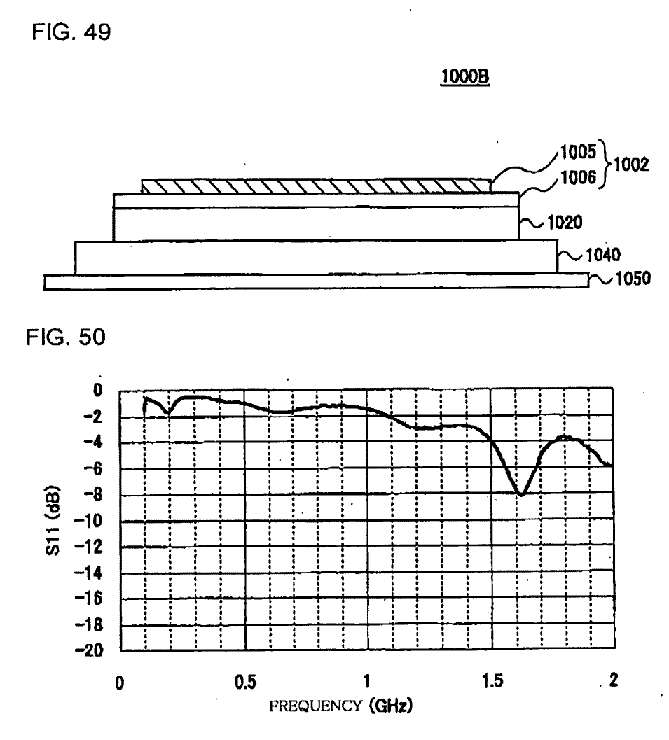

Next, as the antenna device similar to that of above-mentioned Example 6, the antenna device (Comparative Example 1) without the artificial medium 900 between the antenna element 1002 and the metal plate 1050 is produced as a trial, and the characteristics of the antenna device are evaluated using the same measurement method. FIG. 49 shows a cross-sectional view schematically illustrating the antenna device 1000B according to Comparative Example 1. In the drawing, it should be noted that the same components as those in the antenna device (that is, FIGS. 19 to 21) of Example 6 are designated by the same reference numerals.

The measurement result is shown in FIG. 50. With reference to the result, it can be seen that the impedance of the antenna device without the artificial medium 900 according to the invention is not matched.

Comparing FIG. 48 with FIG. 50, it can be seen that the antenna device provided with the artificial medium 900 according to the invention operates properly even though the antenna device is in a state of being close to metal.

In general, in order to use the metal plate as a reflector of the antenna device, the distance between the antenna element and the metal plate is necessarily separated by ¼ of a wavelength of an operating frequency of the antenna. Therefore, it is difficult to make the antenna device have a low profile. However, using the artificial medium 900 according to the invention, the distance between the two can be significantly reduced. That is, in the antenna device provided with the artificial medium 900 according to the invention, there is no need to interpose a layer made of a thick dielectric body or an insulating body between the antenna element and the metal plate, so that it is possible to make the antenna device be downsized with a low profile.

### Example 7

Next, the characteristics of another antenna device 2000 (hereinafter, referred to as “the antenna device 2000 according to Example 7”) provided with the artificial medium according to the above-mentioned third embodiment are evaluated by simulation.

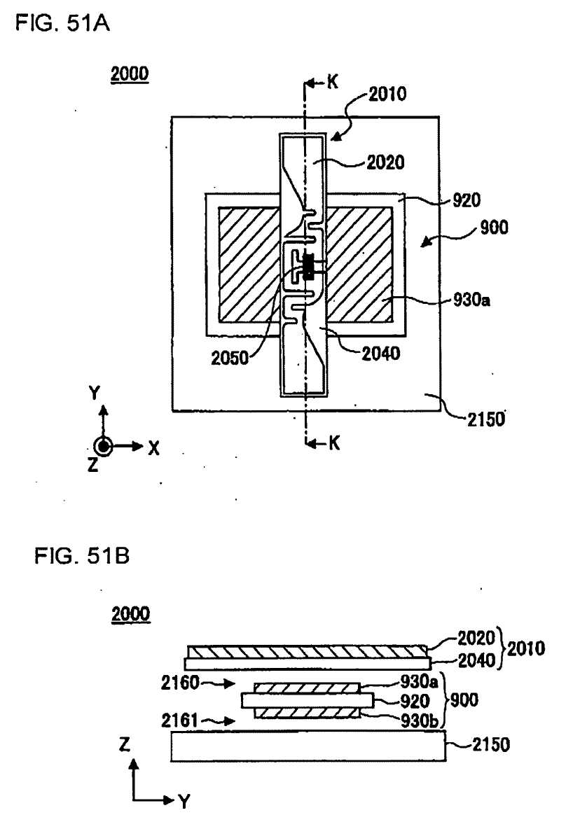

The antenna device 2000 according to Example 7 is configured as shown in FIGS. 51A and 51B. FIG. 51B is a schematic diagram taken along the line K-K in FIG. 51A. (In this case, it should be noted that the patterned radiating conductor 2020 illustrated is simplified in FIG. 51B.)

As shown in FIGS. 51A and 51B, the antenna device 2000 according to Example 7 is constituted by the metal plate 2150, the above-mentioned artificial medium 900, and the antenna element 2010 which are laminated in this order. The antenna element 2010 is an UHF-band RFID tag (Wave inlet made by Omron Co.). The antenna element 2010 is configured such that the radiating conductor 2020 is printed on a PET (Polyethylene Terephthalate) film 2040. Further, on the radiating conductor 2020, an IC chip 2050 is mounted. Between the antenna element 2010 and the artificial medium 900, and between the artificial medium 900 and the metal plate 2150, air layers 2160 and 2161 are formed in order to electrically insulate both, respectively.

The dimensions of the film 2040 are set to 100 mm (length in the Y direction)×20 mm (length in the X direction)×0.038 mm (thickness). The artificial medium 900 is constituted by the dielectric layer 920 (length of 55 mm (length in the Y direction)×width of 90 mm (length in the X direction)×thickness of 1 mm) with permittivity of 3.38, and the single conductive element (930a and 930b) (length of 49.5 mm×width of 81 mm×thickness of 0.01 mm). As shown in the drawing, the film 2040 is disposed on the artificial medium 900 such that the longitudinal direction of the film 2040 is perpendicular to the longitudinal direction of the artificial medium 900 in a rectangular shape. The metal plate 2150 is unlimitedly extended in the XY plane, and the thickness thereof is assumed to be 0.01 mm. In addition, the thickness of the air layers 2160 and 2161 are set to 0.462 mm and 0.5 mm, respectively.

A current direction of the artificial medium is arbitrarily controlled by arrangement or type of the connected antenna element.

Following is an example in a case that a dipole antenna that has a liner shape is disposed on the artificial medium having a rectangle shape.

In a case that a longer direction of the artificial medium and that of the dipole antenna are coincident, electric current is only induced in the longer direction of the artificial medium, the artificial medium can be controlled at a frequency based on a length of the artificial medium in the longer direction.

In a case that a longer direction of the artificial medium and a short-side direction of the dipole antenna are coincident, electric current is only induced in a short-side direction of the artificial medium.

Further, the positional relationship between the artificial medium and the dipole antenna is not satisfy the above-mentioned cases, the above-mentioned two types of electric current are induced, and the artificial medium is controlled at two frequency based on the length of the artificial medium in the longer direction and that in the short-side direction.

Further, in a case that a part of the antenna element is bended as the antenna element 2010 shown in FIG. 51, the two types of electric current are induced at a part of the artificial medium where a lower side of the bended portion of the antenna element, and the antenna element is controlled frequency based on the length of the artificial medium in both of the longer direction and the short-side direction.

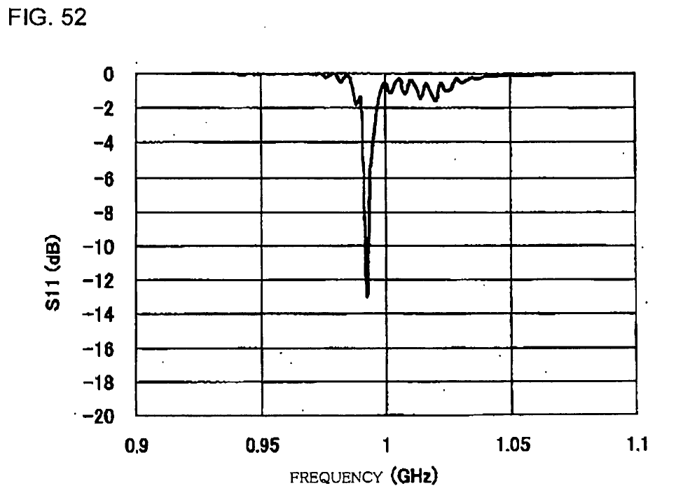

The antenna characteristics of the antenna device 2000 according to Example 7 as described above are evaluated. The antenna characteristics are evaluated using an electromagnetic field simulator (Microwave Studio) based on the FIT (Finite Integration Technique) method. The result is shown in FIGS. 52 to 54. Further, in the simulation, the power feeding point is provided on the mounting position of the IC chip 2050.

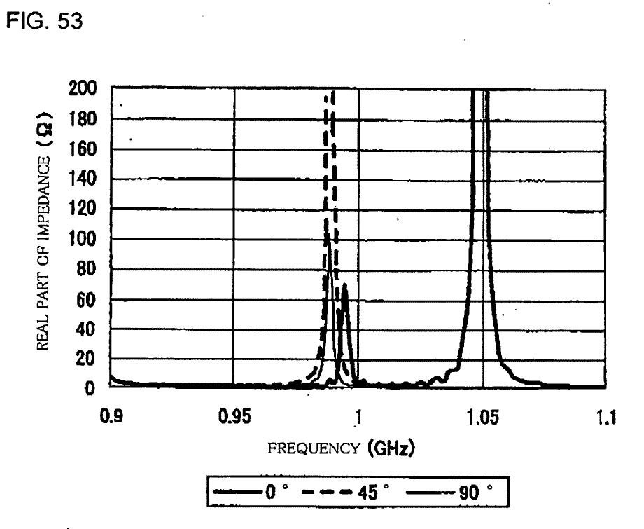

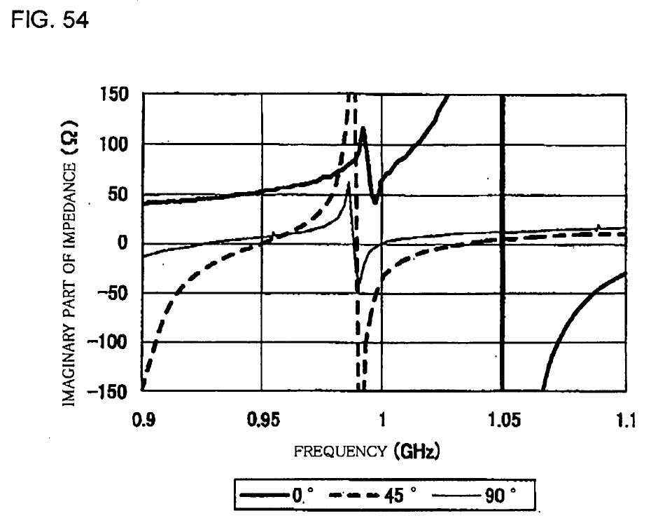

FIG. 52 shows the S11 characteristics of the antenna device 2000 according to Example 7. In addition, FIGS. 53 and 54 show the real part and the imaginary part of an input impedance of the antenna device 2000, respectively. Further, FIGS. 53 and 54 show the results, when the RFID tag 2010 disposed as shown in FIGS. 51A and 51B is rotated by 45° and 90° from the position in the XY plane in the drawing, at the same time.

As shown in FIG. 52, the S11 of the antenna device 2000 is lower than −10 dB in the vicinity of 990 MHz, so it can be seen that good characteristics are shown. In addition, as shown in FIG. 54, it can be seen that the imaginary part of the input impedance of the antenna device is changed along with the rotation angle of the RFID tag 2010. This shows that the input impedance (in particular, a value of the imaginary part) of the antenna device is changed in accordance with the positional relationship between the RFID tap 2010 and the artificial medium 900. That is, by controlling both the positions, it is possible to adjust the input impedance of the antenna device 2000 to be an optimal value.

In general, when the RFID tag is made to be communicated in a state where a metal material is provided at the RFID tag, it is considered that a in-phase reflector using the artificial medium may be effectively used. However, in such a device, there may occur mismatching between the input impedance of the RFID tag and the IC chip, so that the communication performance is degraded. On the contrary, in the case of the antenna device according to the invention, by adjusting the arrangement of the RFID tag, the impedance of the antenna device can be approximated to the input impedance of the RFID tag. Therefore, in the antenna device according to the invention, good communication performance can be obtained.

### Example 8

Next, the characteristics of the second antenna device (the antenna device shown in FIGS. 22 to 23) provided with the artificial medium according to the above-mentioned third embodiment are evaluated by simulation. The second antenna device is configured as the following.

Three artificial mediums 900A to 900C are configured as shown in FIGS. 18A and 18B. The dimensions of the dielectric layer 920 are set to a length of 21.7 mm×width of 17.3 mm×thickness of 1 mm. The dimensions of the conductive element are set to a width of 19.7 mm×length of 15.6 mm. Further, as described above, the artificial medium 900B, which is disposed in the center among the three artificial mediums 900A to 900C, is disposed on the dielectric substrate 1150 such that the longitudinal direction of the conductive element 931B is rotated by 90° compared with the other artificial mediums 900A and 900C.

The dimensions of the dielectric substrate 1150 are set to a width of 21.7 mm×length of 17.3 mm×thickness of 1 mm. The relative permittivity of the dielectric substrate is set to 9.

In the three antenna elements 1120A to 1120C, the outer dimensions (the entire length and the line width) of each of the conductors 1130A to 1130C are set to 36 mm×2 mm, and the thickness is set to 0.01 mm. The respective conductors 1130A to 1130C are disposed in a state of being rotated by 45° in the counterclockwise direction with respect to the Y axis. The space SP between the antenna elements is set to 30 mm.

The antenna device configured as described above is referred to as the antenna device 1100 according to Example 8 of the invention.

(Characteristics Evaluation)

The characteristics of the antenna device 1100 according to Example 8 manufactured as described above are evaluated by simulation.

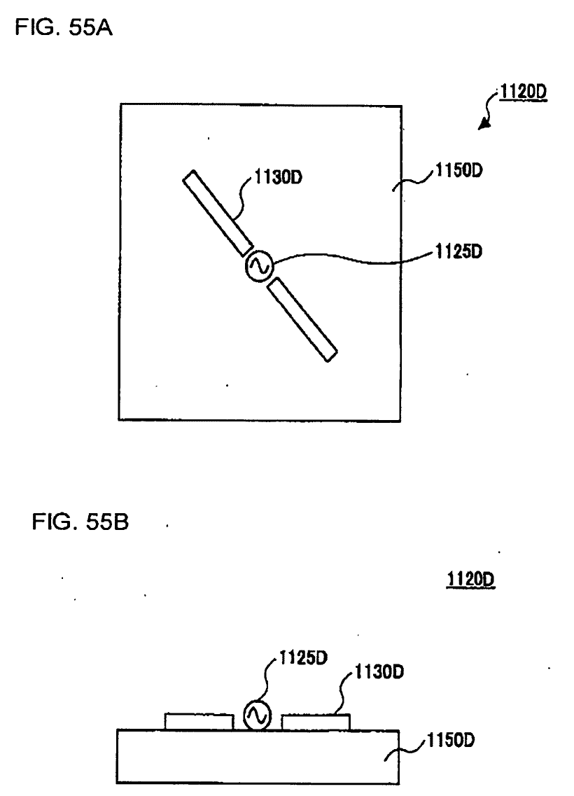

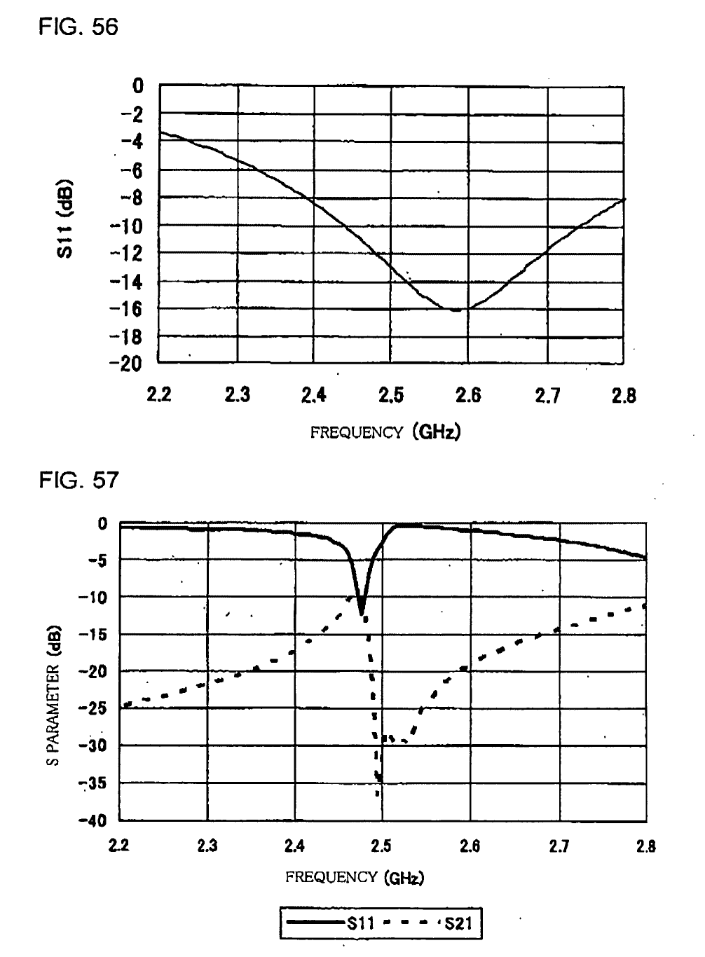

First, in order to confirm the characteristics of a single component of the antenna element, the return loss characteristics of one antenna element 1120D shown in FIGS. 55A and 55B are evaluated. FIG. 55A is a top view of the antenna element 1120D, and FIG. 55B is a cross-sectional view of the antenna element 1120D. The antenna element 1120D is provided with the conductor 1130D and the power feeding point 1125D on the surface of the dielectric substrate 1150D. The dimensions of the dielectric substrate 1150D are set to a width of 100 mm×length of 50 mm, and the relative permittivity is set to 9. The result is shown in FIG. 56. With reference to the obtained S11 characteristics, it can be seen that the antenna element efficiently operates at about 2.6 GHz.

Next, the antenna device configured as shown in FIGS. 22 and 23 is analyzed. The result is shown in FIG. 57. Further, the result is obtained from the antenna element 1120B in the center. Further, in the simulation result, since the S21 characteristics and the S31 characteristics are equal, only the S11 and S21 are displayed in FIG. 57.

When the radiation efficiency in a matching frequency is calculated by the following Equation, the radiation efficiency η becomes 74.8%.

Radiation Efficiency η=1−S11²−S21²−S31²

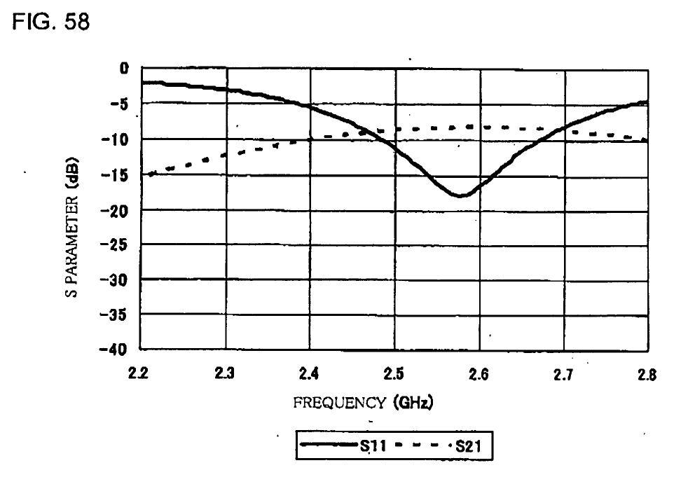

On the other hand, the result obtained from the antenna device which is similarly configured but does not have the artificial medium group 901 is shown in FIG. 58. Similar to the above-mentioned case in FIG. 57, the result is obtained from the antenna element in the center. When the radiation efficiency η in a matching frequency is calculated from the result, η becomes 67.9%. As a result, in the antenna device without the artificial medium, the antenna element in the center is affected by the interference of both the antenna elements on either side, so that the radiation efficiency is lowered. On the other hand, it can be seen that in the antenna device with the artificial medium, the interference hardly occurs, so that it is possible to obtain high radiation efficiency.

The result shows that the antenna elements can be disposed close to each other using the artificial medium according to the invention. Therefore, it is possible to make the antenna device be downsized with a low profile.

### Example 9

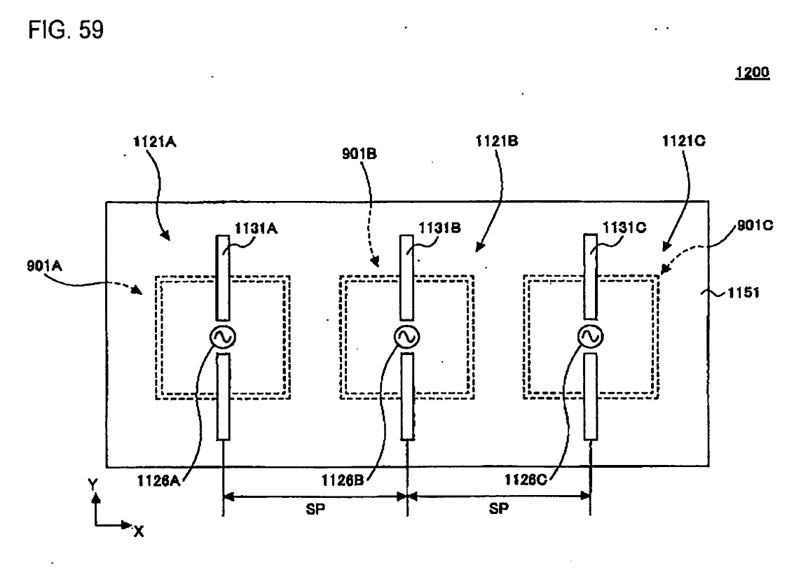

Next, the characteristics of the antenna device 1200 configured as shown in FIG. 59 are evaluated by simulation. Here, the antenna device 1200 is configured similarly to the above-mentioned antenna device 1100. However, the antenna device 1200 is different from the above-mentioned antenna device 1100 in that conductors 1131A to 1131C of three antenna elements 1121A to 1121C are extended in parallel to the Y direction and all of the conductive elements of the artificial medium 901 are in a square shape. The antenna device configured as described above is called the antenna device according to Example 9 of the invention.

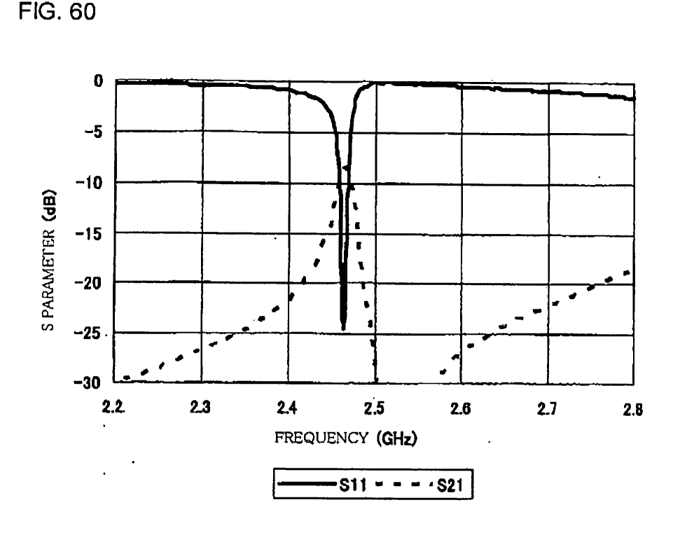

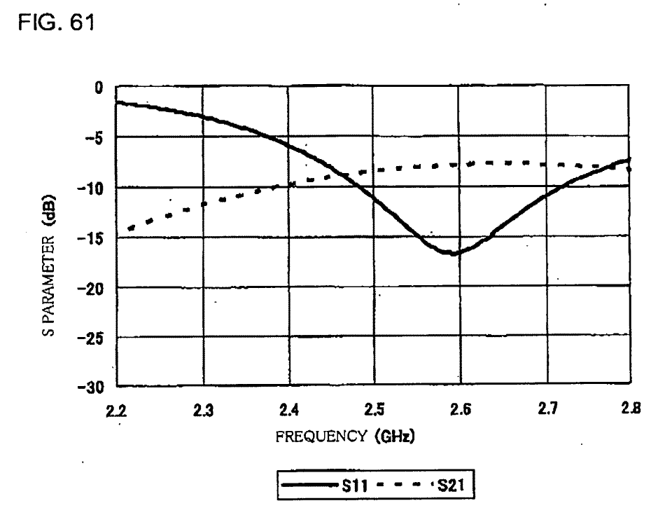

FIG. 60 shows the result which is obtained by analyzing the characteristics of the antenna device 1200 by the same simulation as that of Example 8 described above. In addition, FIG. 61 shows the simulation result of the characteristics in a case where the artificial mediums 901A to 901C are removed in the antenna device 1200. Here, FIGS. 60 and 61 show the results obtained from the antenna element in the center.

When the radiation efficiency η in the matching frequency is compared in both the drawings, η becomes 71.4% in the case of the antenna device 1200, and η becomes 65.4% in the case of the antenna device without the artificial medium. As a result, it can be seen that the interference between the antenna elements is suppressed by providing the artificial medium in the antenna device 1200, so that the radiation efficiency increases.

The result shows that the antenna elements can be disposed close to each other using the artificial medium according to the invention. Therefore, it is possible to make the antenna device be downsized with a low profile.

### Example 10

Next, the characteristics of the antenna device 1300 configured as shown in FIGS. 24 and 25 are evaluated by simulation. Here, the antenna device 1300 is configured as the following.

The artificial medium 900 is configured similar to that (for example, the artificial medium 900A) which is used in the antenna device 1100 shown in FIGS. 22 and 23. The dimensions of the dielectric layer 920 are set to a length of 21.7 mm×width of 8.68 mm×thickness of 1 mm. The dimensions of the conductive element are set to a width of 19.5 mm×length of 7.8 mm.

The dimensions of the dielectric substrate 1150 are set to a width of 40 mm×length of 40 mm×thickness of 1 mm. The relative permittivity of the dielectric substrate is set to 9.

In the antenna element 1120, the outer dimensions (the entire length and the line width) of the conductor 1130 are set to 36 mm×2 mm, and the thickness is set to 0.01 mm. The respective conductor 1130 is disposed in a state of being rotated by 45° in the counterclockwise direction with respect to the Y axis.

The antenna device configured as described above is referred to as the antenna device according to Example 10.

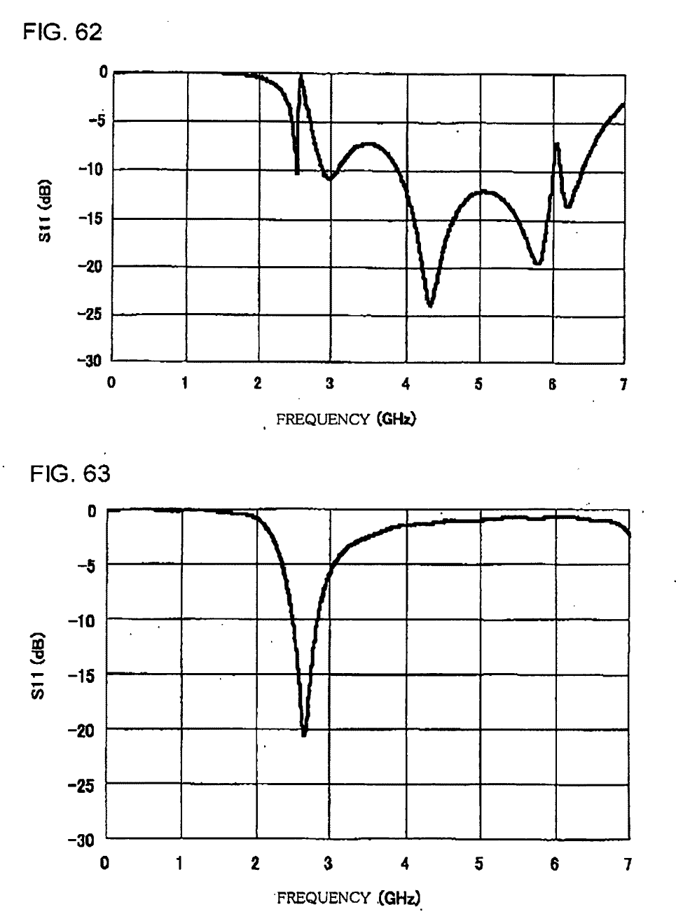

FIG. 62 shows the result which is obtained by analyzing the characteristics of the antenna device 1300 by the same simulation as that of Example 8 described above. In addition, FIG. 63 shows the simulation result of the characteristics in a case where the artificial medium 900 is removed in the antenna device 1300.

With reference to FIG. 62, it can be seen that the antenna device according to Example 10 is matched in two frequency regions of 2.5 GHz and from about 4 GHz to about 6 GHz. On the other hand, with reference to FIG. 63, when the artificial medium 900 is removed, it can be seen that the antenna device is matched only in a frequency of about 2.5 GHz.

As described above, it can be seen that the antenna device according to Example 10, which is provided with the artificial medium 900 according to the invention, can be used as a broadband antenna with multiple resonance.

### Example 11

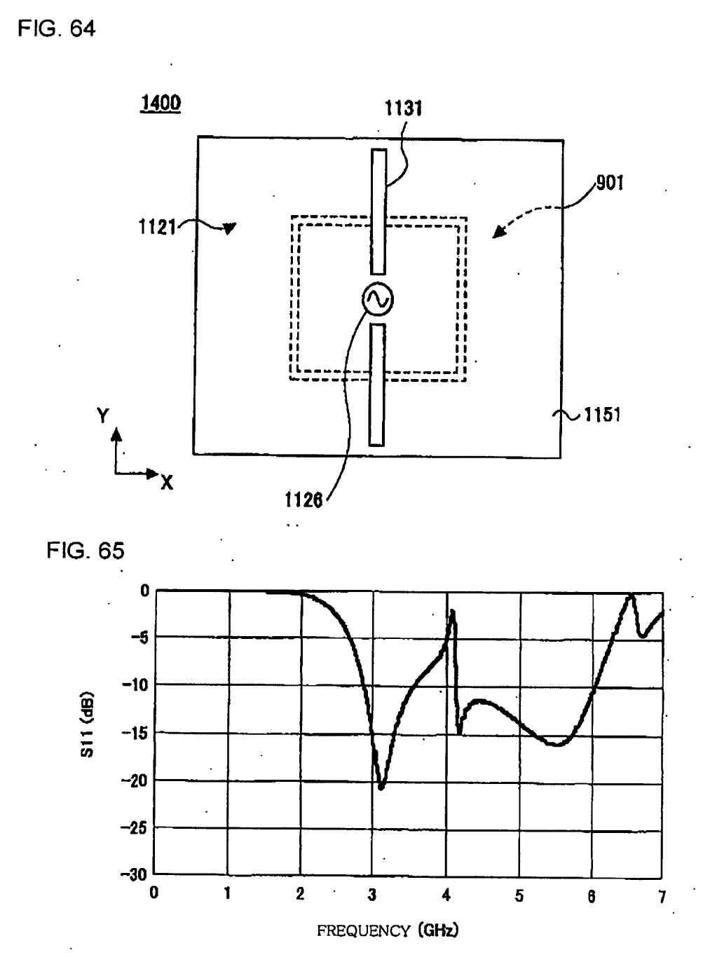

Next, the characteristics of the antenna device 1400 according to Example 11 of the invention, which is configured as shown in FIG. 64, are evaluated by the same simulation. Here, the antenna device 1400 is configured similar to the above-mentioned antenna device 1300. However, the antenna device 1400 is different from the above-mentioned antenna device 1300 in that the conductor 1131 of the antenna device 1121 is extended in parallel to the Y direction. Further, as shown in FIG. 59, it should be noted that the artificial medium, the power feeding point, and the dielectric substrate are designated by the reference numerals 901, 1126, and 1151 in FIG. 64, respectively.

In the artificial medium 901, the dimensions of the dielectric layer 920 are set to a length of 21.7 mm×width of 13.02 mm×thickness of 1 mm. In addition, the dimensions of the conductive element are set to a width of 19.5 mm×length of 11.7 mm. Other dimensions are similar to the case in Example 10.

FIG. 65 shows the result which is obtained by analyzing the characteristics of the antenna device 1400 according to Example 11 by simulation.

With reference to the drawing, it can be seen that the antenna device is matched in two frequency regions of about 3 GHz and from about 4 GHz to about 6 GHz.

As described above, it can also be seen that the antenna device 1400 according to Example 11 can be used as a broadband antenna with multiple resonance.

### INDUSTRIAL APPLICABILITY

The artificial medium of the invention can be employed for, for example, high-frequency antennas, micromini resonators for communication, transmitters, and the like.

1. An artificial medium on which two or more conductive surfaces are provided in a thickness direction, the conductive surface being provided with conductive elements in a two-dimensional periodic array,
wherein when an electromagnetic wave propagated in parallel to the thickness direction is incident on the artificial medium, a current excited by the electromagnetic wave increases in an operation frequency, and a current loop is formed in a surface parallel to the thickness direction.

2. The artificial medium according to claim 1,
wherein a dielectric layer is interposed between the respective conductive surfaces, and
wherein the current loop is formed in a region in which the respective conductive elements face each other in a thickness direction via each dielectric layer.

3. The artificial medium according to claim 2,
wherein the conductive surfaces each has substantially the same arrangement pattern which is constituted by a plurality of conductive elements separated from each other, and
wherein the respective conductive elements are uniformly positioned along the thickness direction.

4. The artificial medium according to claim 3,
wherein the respective conductive elements have substantially the same shape and dimension.

5. The artificial medium according to claim 4,
wherein inside the dielectric layer, a plurality of first linear conductor elements are disposed in parallel to each other in the vicinity of a center portion in the thickness direction of the dielectric layer,
wherein the first linear conductor elements extend substantially in a linear shape from one end of the dielectric layer to the other end thereof, and
wherein when seen from a direction perpendicular to the conductive surfaces, at least one of the first linear conductor elements is disposed to be overlapped with at least any one of the conductive elements.

6. The artificial medium according to claim 5, further comprising:
a plurality of second linear conductor elements which are disposed in parallel to each other in the same depth position as that of the plurality of the first linear conductor elements,
wherein the plurality of the second linear conductor elements extend substantially in a linear shape from one end of the dielectric layer to the other end thereof along a direction different from that of the first linear conductor elements, and
wherein when seen from a direction perpendicular to the conductive surfaces, at least a part of the plurality of second linear conductor elements is disposed to be overlapped with at least any one of the conductive elements.

7. The artificial medium according to claim 6,
wherein when seen from a direction perpendicular to the conductive surfaces, the first and second linear conductor elements are disposed such that intersections between the first linear conductor elements and the second linear conductor elements are included in a region of any conductive element.

8. The artificial medium according to claim 5,
wherein the conductive elements are arranged at a constant pitch along rows and columns in the conductive surface,
wherein when seen from a direction perpendicular to the conductive surfaces, at least one of the first linear conductor elements is disposed to be overlapped with the respective conductive elements constituting one column, and/or
wherein when seen from a direction perpendicular to the conductive surfaces, at least one of the second linear conductor elements is disposed to be overlapped with the respective conductive elements constituting one row.

9. The artificial medium according to claim 5,
wherein the conductive elements are arranged at a constant pitch along rows and columns in the conductive surface,
wherein the first linear conductor elements are disposed at a pitch substantially equal to the pitch between the columns of the conductive elements, and/or
wherein the second linear conductor elements are disposed at a pitch substantially equal to the pitch between the rows of the conductive elements.

10. The artificial medium according to claim 9,
wherein when seen from a direction perpendicular to the conductive surfaces, the conductive elements are disposed on all of the intersections between the first and second linear conductor elements, and are not disposed on positions other than the intersections.

11. The artificial medium according to claim 5,
wherein the conductive elements are arranged at a constant pitch along rows and columns in the conductive surface,
wherein the first linear conductor elements are disposed at a pitch substantially two times the pitch between the columns of the conductive elements, and/or
wherein the second linear conductor elements are disposed at a pitch substantially two times the pitch between the rows of the conductive elements.

12. The artificial medium according to claim 6,
wherein the conductive elements are arranged at a constant pitch along rows and columns in the conductive surface,
wherein the plurality of the first linear conductor elements and the second linear conductor elements are disposed at the almost same space,
wherein the first linear conductor elements are disposed to extend in a direction rotating by 45° in the clockwise direction with respect to a direction of the columns of the conductive elements, and
wherein the first linear conductor elements are disposed to extend in a direction rotating by 45° in the counterclockwise direction with respect to a direction of the columns of the conductive elements.

13. The artificial medium according to claim 12,
wherein when seen from a direction perpendicular to the conductive surfaces, the conductive elements are disposed on all of the intersections between the first and second linear conductor elements, and are not disposed on positions other than the intersections.

14. The artificial medium according to claim 4,
wherein the plurality of conductive elements have substantially a square shape.

15. The artificial medium according to claim 5,
wherein a line width of the first linear conductor element and/or the second linear conductor element is narrower than a width of the conductive element in the same direction.

16. The artificial medium according to claim 5,
wherein a line width of the first linear conductor element and/or the second linear conductor element is wider than a width of the conductive element in the same direction.

17. The artificial medium according to claim 1,
wherein the dielectric layer is configured of a fluororesin-based resin material.

18. A method of manufacturing an artificial medium, comprising the steps of:
preparing dielectric substrates each having a conductive surface on which conductive elements are disposed; and
forming an artificial medium by laminating the dielectric substrates in a thickness direction,
wherein the step of preparing the dielectric substrate includes a step of disposing the conductive elements in the respective dielectric substrates such that a current loop is formed in a plane parallel to the thickness direction, when an electromagnetic wave propagated in a direction parallel to the thickness direction is incident on the artificial medium.

19. The method of manufacturing the artificial medium according to claim 18,
wherein a current loop is formed between the conductive elements facing to each other with one dielectric substrate interposed therebetween in the thickness direction.

20. The method of manufacturing the artificial medium according to claim 18,
wherein the step of forming the artificial medium by laminating the dielectric substrates in the thickness direction includes a step of interposing a second dielectric layer without the conductive elements between the dielectric substrates in which the conductive elements are disposed on the conductive surface.

21. The method of manufacturing the artificial medium according to claim 18,
wherein the step of preparing the dielectric substrate further includes the steps of:
disposing linear conductor elements in the vicinity of the center portion in the thickness direction of the dielectric layer; and
providing substantially the same pattern, which is constituted by a plurality of conductive elements, on a conductive surface of each dielectric substrate such that the conductive elements are uniformly positioned along the thickness direction, when the dielectric substrates are laminated,
wherein the respective conductive elements have substantially the same shape and dimension,
wherein the linear conductor elements extend substantially in a linear shape from one end of the dielectric substrate to the other end thereof, and
wherein when seen from a direction perpendicular to the conductive surfaces, at least a part of the linear conductor elements is disposed to be overlapped with at least any one of the conductive elements.

22. An artificial medium comprising:
a dielectric layer; and
a single conductive element which is provided on each of front and rear surfaces of the dielectric layer,
wherein the respective conductive elements have substantially the same shape and dimensions, and are uniformly positioned along a thickness direction of the dielectric layer, and
wherein when an electromagnetic wave propagated in a direction parallel to the thickness direction is incident, a current loop is formed on a region in which the conductive elements face each other with the dielectric layer interposed therebetween in the thickness direction.

23. An antenna device in which an antenna element with a conductor is disposed on a first surface of a substrate which is constituted by an insulating body or a dielectric body,
wherein an artificial medium is disposed on a second surface opposite to the first surface of the substrate,
wherein the artificial medium is constituted by the artificial medium according to claim 22, and
wherein when seen from a direction perpendicular to the first surface of the substrate, at least a part of the antenna element is overlapped with the artificial medium.

24. The antenna device according to claim 23,
wherein a metal plate is further disposed on a side of the artificial medium opposite to the second surface of the substrate.

25. The antenna device according to claim 24,
wherein the antenna element has an RFID tag.
